(19) United States
(12) Patent Application Publication
(10) Pub. No.: US 2007/0219771 A1
(43) Pub. Date: Sep. 20, 2007

(54) Branching and Behavioral Partitioning for a VLIW Processor

(76) Inventors: Henry T. Verheyen, San Jose, CA (US); Paraminder S. Sahai, San Jose, CA (US); William Watt, San Jose, CA (US); Paul Colwill, Morgan Hill, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/735,865

(22) Filed: Apr. 16, 2007

Related U.S. Application Data
(63) Continuation-in-part of application No. 11/292,712, filed on Dec. 1, 2005.
(63) Continuation-in-part of application No. 11/296,007, filed on Dec. 6, 2005.
(60) Provisional application No. 60/744,991, filed on Apr. 17, 2006.

(51) Int. Cl. G06F 17/50

(52) U.S. Cl. 703/15

(57) ABSTRACT

In one aspect, the present invention overcomes the limitations of the prior art by provident a logic simulation ;system that uses a VLIW simulation processor with many parallel processor elements to accelerate the simulation of synthesizable tasks but that also supports non-synthesizable tasks and/or branching. In one approach, the VLIW simulation processor is based on an architecture that does not have an on-chip instruction cache. Instead, VLIW instruction words stream in directly from a program memory and the individual processor elements are programmed continuously based on the instruction words. This also allows the efficient implementation of side-entrance jumps, where a region of code can be entered in the middle of the region rather than always requiring entrance from the top. In another aspect, non-synthesizable tasks can be efficiently handled by exception handlers.

### CROSS-REFERENCE TO RELATED APPLICATION(S)

This application is (a) a continuation-in-part of U.S. patent application Ser. No. 11/292,712, “Hardware Acceleration System for Simulation of Logic and Memory,” filed Dec. 1, 2005 by Henry T. Verheyen and William Watt; (b) a continuation-in-part of U.S. patent application Ser. No. 11/296,007, “Partitioning of Tasks for Execution by a VLIW Hardware Acceleration System,” filed Dec. 6, 2005 by Henry T. Verheyen and William Watt; and (c) claims priority under 35 U.S.C. § 119(e) to U.S. Provisional Patent Application Ser. No. 60/744,991, “Branching and Behavioral Partitioning for a VLIW Processor,” filed Apr. 17, 2006 by Henry T. Verheyen et al. The subject matter of all of the foregoing is incorporated herein by reference in their entirety.

### BACKGROUND OF THE INVENTION

1. Field of the Invention

The present invention relates generally to VLIW (very long instruction word) processors, including for example simulation processors that may be used in hardware acceleration systems for simulation of the design of semiconductor integrated circuits, also known as semiconductor chips. One aspect of the invention relates to various approaches for implementing branching and/or for partitioning tasks for a VLIW processor and in one particular case specifically for a VLIW processor without on-chip instruction cache.

2. Description of the Related Art

Simulation of the design of a semiconductor chip typically requires high processing speed and a large number of execution steps due to the large amount of logic in the design, the large amount of on-chip and off-chip memory, and the high speed of operation typically present in the designs for modern semiconductor chips. The typical approach for simulation is software-based simulation (i.e., software simulators). In this approach, the logic and memory of a chip (which shall be referred to as user logic and user memory for convenience) are simulated by computer software executing on general purpose hardware. The user logic is simulated by the execution of software instructions that mimic the logic function. The user memory is simulated by allocating main memory in the general purpose hardware and then transferring data back and forth from these memory locations as needed by the simulation. Unfortunately, software simulators typically are very slow. The simulation of a large amount of logic on the chip requires that a large number of operands, results and corresponding software instructions be transferred from main memory to the general purpose processor for execution. The simulation of a large amount of memory on the chip requires a large number of data transfers and corresponding address translations between the address used in the chip description and the corresponding address used in main memory of the general purpose hardware.

Another approach for chip simulation is hardware-based simulation (i.e., hardware emulators). In this approach, user logic and user memory are mapped on a dedicated basis to hardware circuits in the emulator, and the hardware circuits then perform the simulation. User logic is mapped to specific hardware gates in the emulator, and user memory is mapped to specific physical memory in the emulator. Unfortunately, hardware emulators typically require high cost because the number of hardware circuits required in the emulator increases according to the size of the simulated chip design. For example, hardware emulators typically require the same amount of logic as is present on the chip, since the on-chip logic is mapped on a dedicated basis to physical logic in the emulator. If there is a large amount of user logic, then there must be an equally large amount of physical logic in the emulator. Furthermore, user memory must also be mapped onto the emulator, and requires also a dedicated mapping from the user memory to the physical memory in the hardware emulator. Typically, emulator memory is instantiated and partitioned to mimic the user memory. This can be quite inefficient as each memory uses physical address and data ports. Typically, the amount of user logic and user memory that can be mapped depends on emulator architectural features, but both user logic and user memory require physical resources to be included in the emulator and scale upwards with the design size. This drives up the cost of the emulator. It also slows down the performance and complicates the design of the emulator. Emulator memory typically is high-speed but small. A large user memory may have to be split among many emulator memories. This then requires synchronization among the different emulator memories.

Still another approach for logic simulation is hardware-accelerated simulation. Hardware-accelerated simulation typically utilizes a specialized hardware simulation system that includes processor elements configurable to emulate or simulate the logic designs. A compiler is typically provided to convert the logic design (e.g., in the form of a netlist or RTL (Register Transfer Language)) to a program containing instructions which are loaded to the processor elements to simulate the logic design. Hardware-accelerated simulation does not have to scale proportionally to the size of the logic design, because various techniques may be utilized to partition the logic design into smaller portions (or domains) and load these domains to the simulation processor. As a result, hardware-accelerated simulators typically are significantly less expensive than hardware emulators. In addition, hardware-accelerated simulators typically are faster than software simulators due to the hardware acceleration produced by the simulation processor.

However, hardware-accelerated simulators typically require coordination between overall simulation control and the simulation of a specific domain that occurs within the accelerated hardware simulator. For example, if the user design is simulated one domain at a time, some control is required to load the current state of a domain into the hardware simulator, have the hardware simulator perform the simulation of that domain, and then swap out the revised state of the domain (and possibly also additional data such as results or error messages) in exchange for loading the state of the next domain to be simulated. As another example, commands for functions that are not executed by the hardware simulator (e.g., commands that are executed by a host computer) typically also need to be coordinated with the hardware simulator. Reporting, interrupts and errors, and branching within the simulation are some examples.

These functions preferably are implemented in a resource-efficient manner and with low overhead. For example, swapping state spaces for different domains preferably occurs without unduly delaying the simulation. Therefore, there is a need for an approach to hardware-accelerated functional simulation of chip designs that overcomes some or all of the above drawbacks.

### SUMMARY OF THE INVENTION

In one aspect, the present invention overcomes the limitations of the prior art by providing a logic simulation system that uses a VLIW simulation processor with many parallel processor elements to accelerate the simulation of synthesizable tasks but that also supports non-synthesizable tasks and/or branching.

In one approach, the VLIW simulation processor is based on an architecture that does not have an on-chip instruction cache. Instead, VLIW instruction words stream in directly from a program memory and the individual processor elements are programmed continuously based on the instruction words. As a result, code branching can be implemented with almost no execution penalty since instruction cache synchronization is not required, unlike conventional VLIW processor architectures which use instruction caches. This also allows the efficient implementation of side-entrance jumps, where a region of code can be entered in the middle of the region rather than always requiring entrance from the top. The availability of side-entrance jumps, in turn, allows the formation of larger regions, which generally increases scheduling efficiency and instruction level parallelism. This is in direct contrast to conventional VLIW processor architectures which generally do not allow side-entrance jumps because of the corresponding cache synchronization requirements.

In another aspect, non-synthesizable tasks (i.e., tasks that are not suited for efficient execution by the VLIW processor elements) are efficiently accomplished via exception handlers. Even if calls and execution of exception handlers have relatively high latency, if the latency is predictable, high overall execution efficiency can still be maintained by scheduling the exception handlers in a manner that accounts for their latency and allows other parallel operations to execute simultaneously within the VLIW simulation processor.

In the context of logic simulation, the logic operations of user logic are the primary example of a synthesizable task. These are meant to go in-circuit and are normally synthesized. The VLIW processor elements are designed to efficiently simulate these logic operations. On the other hand, examples of non-synthesizable tasks include many behavioral models (such as user memory models), many test bench functions (such as initial, repeat, forever, unbounded loops, event, real, time, fork, join, procedural assignments, certain operators) and overall control of the simulation (such as #delay, incomplete sensitivity lists, non-local reference, behavioral control). Typically, both synthesizable and non-synthesizable tasks are required to simulate a chip design. As a result, the approach described above that uses VLIW processor elements to accelerate execution of synthesizable tasks while simultaneously supporting the efficient execution of non-synthesizable tasks (for example, by exception handlers) can significantly accelerate the overall logic simulation.

In one specific implementation, the logic simulation system is implemented as a dedicated hardware simulator implemented on a printed circuit board (PCB), which plugs into a host computer. The dedicated hardware simulator includes a program memory for storing VLIW instruction words, storage memory for storing data among other information, and the VLIW simulation processor. The VLIW simulation processor is implemented as one chip, while the program memory and storage memory are implemented as separate (memory) chips on the PCB. Within this architecture, exception handlers can generally be classified as either behavioral primitives (which are either implemented on-chip with the VLIW simulation processor, or on-PCB) or as embedded behaviors (which are either Host CPU-based or Host Program-based). In one implementation, exception handlers are triggered by special opcodes for the VLIW simulation processor. For example, certain field overloads may be defined as triggering various exception handlers.

In addition, more complex simulations often will require more complex types of dynamic, or runtime control, typically realized through branching. Domains are used to implement branching. The overall task to be executed is subdivided into groups of instructions or tasks, which are referred to as domains. Domains can be connected to each other at run-time by branching from one domain to the next domain, where the next domain might depend on certain conditions (conditional branching). Loops, if-then and case statements can also be implemented. In the VLIW architecture described above, a program counter (PC) register points to the address in the program memory of the next instruction to be streamed to the VLIW processor. A branch can be implemented simply by loading the PC register with a new address for the program memory (rather than automatically incrementing the PC register). Conditional branches (as well as multi-way branches) can be implemented by having the new address for the PC register depend on the evaluation of a condition.

Branch commands can be encoded as special opcodes, for example field overloads. If the VLIW simulation processor receives this special opcode, this triggers the loading of the new address into the PC register. Many kinds of branches can be implemented. For example, JUMP commands could be either global (where the address provided is the global address to be loaded into the PC register) or relative (where the address provided is the amount to increment or decrement the current PC register). JUMP commands can also be conditional or unconditional. In unconditional JUMPs, the new address is always loaded into the PC register. In conditional JUMPs, whether the address is loaded depends on evaluation of a condition. That condition may be evaluated in a previous cycle. Alternately, it may be evaluated in the same cycle, either by the same processor element or by a different processor element (recall that the VLIW simulation processor typically has a large number of parallel processor elements). In fact, multi-way JUMPs (e.g., CASE statements) may be implemented in a single cycle by having multiple processing elements evaluate each of the cases at the same time, with the case that is TRUE executing the JUMP.

This concept can be extended to further optimize execution. A certain code section may be able to be compiled into different variants, each of which may execute more efficiently in certain cases. For example, if a piece of code has a loop in it, it may be more efficient just to unroll the loop and replicate the loop body N times if the number of loop iterations N is small. On the other hand, it may be more efficient to implement the loop as a call and return from a “subroutine” (the loop body) followed by a conditional test, if N is large. The compiler can create both variants and then include a branch instruction that selects the unrolled variant if N is small and the subroutine-invoking variant if N is large.

The instruction cache-less VLIW architecture described above can also support side-entrance jumps. A side-entrance jump is a jump to the middle of a domain (as opposed to always entering the domain from the top). Returns are a special case of the side-entrance jump, which allows a domain that was invoked from a calling domain to return to the calling domain. Side-entrance jumps (and recursion, generally) are generally avoided by conventional VLIW architecture because the side-entrance jump is expensive. In fact, many techniques have been developed to avoid side-entrace jumps and, in statically scheduled VLIW architectures, they are not even possible. In conventional VLIW, the side-entrance jump is costly due to the instruction cache synchronization problem and because the status of temporary variables must be accounted for.

However, in the architecture described above, side-entrance jumps can be implemented relatively efficiently. As described above, cache synchronization is not a significant issue for the instruction cache-less architecture. With respect to temporary variables, in one approach, the scheduler simply invalidates the temporary data, resulting in reloading of temporaries for the parent domain and re-computing the parallel operations that were already being scheduled. This is in fact similar to how a single processor would have to operate if it has no stack. In an alternative approach, the invoked domain is not allowed to remove any temporaries. It must preserve them. Nor is it allowed to reuse the scratch pad already in use. It must operate within the available empty slots. In a third approach, the branching instruction can operate freely on the condition that it synchronizes the temporaries to the same state they would have been in had branching not occurred. In the current VLIW architecture, this synchronization can be performed without regards for the program and temporary content as this is an architectural phenomenon, in contrast to the first aforementioned approach which requires excessive bookkeeping algorithms to be correct. An additional advantage is that either of these latter two approaches can be implemented without hardware change to the VLIW simulation processor and the compiler can select the better approach for any given situation.

One advantage of the efficient support of non-synthesizable tasks and branching is that the compiler can create larger regions, which generally results in more efficient scheduling. VLIW scheduling generally includes region formation and schedule construction. Traditionally, a region is a group of domains that can only be entered from the top. Region formation includes partitioning the program/design into regions and parallelizing the execution of instructions in the region. Schedule construction includes compacting the scheduling for the region (i.e., scheduling the program/design) and connecting the regions in the program/design (i.e., add the control logic).

Traditional VLIW architectures have difficulty with and typically do not support side-entrance jumps into a region (or, in logic simulation acceleration terms, the basic block for the execution of non-synthesizable tasks) due to the synchronization problem. Although many techniques have been proposed, as far as the inventors are aware, none allow arbitrary side-entrance into a region. As a result, traditional VLIW schedulers typically must break a program into separate regions if either a side-entrance jump or a non-synthesizable task is encountered. However, the VLIW approach described above can handle both of these and, as a result, the corresponding scheduler can create larger regions resulting in greater scheduling efficiency (i.e., greater instruction level parallelism). In fact, regions can form arbitrary boundaries, enabled by multiple side-entrance points, and compiler optimization can be applied for further efficiency. This is a significant departure from traditional VLIW scheduling, whether statically or dynamically executed, leading to a higher level of ILP (instruction level parallelism).

Region formation can be viewed as making tradeoffs between schedule instructions and control instructions. Schedule instructions can be thought of as different domains (which will be referred to as execution domains) and control instructions can be thought of as the various jump instructions. In traditional VLIW scheduling, a control instruction causes a region to be broken into multiple, smaller regions (e.g., to avoid cache coherency issues). However, it is generally desirable to increase the size of regions in order to increase computational efficiency for VLIW scheduling. In contrast, under the current architecture, the VLIW processor reads each instruction directly from off-chip memory. Since the on-chip instruction cache has been eliminated (and therefore also the cache coherence problem), this allows scheduling of jumps from one execution domain to another execution domain with almost no cost. In other words, VLIW efficiency does not depend as much on the size of the execution domain. A region can be made up out of many execution domains. In this case, the path through the execution domains, the trace, can be dynamically adjusted to only execute the trace that, under dynamic control, happens to be activated. All other traces are not executed.

Traditional VLIW region enlargement techniques can be applied to increase the size of regions. However, other region enlargement techniques, which are not necessarily applicable to traditional VLIW scheduling, can further be used as the number of processing elements in this particular VLIW processor architecture grows. Generally, enlargement techniques enable higher VLIW efficiency, such as loop unrolling. However, with a large number of processors, it is sometimes better to compute both expressions of an if-then-else construct (if-conversion), rather than jumping to an if- or else-execution domain (control flow mapping). In some cases, if basic block jumping and branching were scheduled, full efficiency of the VLIW processor may not be reached.

In the description above, it was assumed that all processor elements receive instructions streamed in from the same address in program memory. This was done for clarity of explanation but is not required. In another aspect, multi-threading can be supported. In one implementation, the access to the program memory is implemented by multiple memory controllers acting in parallel, with each memory controller retrieving instruction words for a certain group of processor elements. Each memory controller could retrieve instruction words from a different location in program memory, thus allowing multi-threaded operation.

Other aspects of the invention include methods, devices, systems and applications corresponding to the approaches described above. Further aspects of the invention include the VLIW techniques described above but applied to applications other than logic simulation.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1 is a block diagram illustrating a hardware-accelerated simulation system.

FIG. 2 is a block diagram illustrating a simulation processor in the hardware-accelerated simulation system.

FIG. 3 is a diagram illustrating simulation of different domains by the simulation processor.

FIG. 4 is a block diagram illustrating an interface between the simulation processor and the program memory and storage memory.

FIGS. 5A and 5B are block diagrams illustrating exception handlers.

FIG. 6 is a diagram illustrating an example organization of execution domains.

FIGS. 7A-7D are diagrams illustrating various aspects of execution domains.

FIG. 8 is a diagram illustrating organization of execution domains within a clock domain.

FIG. 9 is a flow diagram illustrating VLIW scheduling.

FIGS. 10A and 10B are block diagrams illustrating a memory architecture for the program memory 121.

FIG. 11 is a block diagram illustrating processor clustering to support multi-threading.

FIG. 12 is a block diagram of an organization for the program memory to support multi-threading.

FIGS. 13A-13B are diagrams illustrating multi-threaded support for branching.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE PREFERRED EMBODIMENTS

Outline

1. System Architecture

1.A. Overview
1.B. Simulation Processor
1.C. PE Opcode
1.D. Event-Driven and Cycle-Based Simulators
1.E. Clock Domains
   2. Non-synthesizable Tasks
   3. Exception Handlers
3.A. Extended Architecture
3.B. Loopback Exception Handlers
3.C. Opcodes for Invoking Exception Handlers
3.D. On-chip Based, On-PCB Based, Host CPU Based and Host Program Based Exception Handlers
3.E. Behavioral Primitives and Embedded Behaviors
   4. Branching
4.A. JUMP Opcodes
4.B. Latency
4.C. Stackless and Stacked Operation
4.D. Domain Implementation using Branching
4.E. Some Examples
4.F. Multi-way Branch and Control Variable Analysis
   5. Complex Execution Domains
5.A. Non-Synthesizable Tasks and Branching
5.B. Example Execution Domains
5.C. Example Clock Domain Organization
   6. VLIW Compilation and Scheduling
6.A. Overview
6.B. Region Enlargement
6.C. In-lined, Invoked or Unrolled, including Dynamic Conditions
6.D. Synthesis Extensions for Behavioral Mapping.
6.E. Parallelization
6.F. Schedule Construction: Compaction, Controls and Organization
6.G. Summary
   7. Multi-threading
7.A. Architecture Extensions
7.B. Multi-threaded Support for Branching
   8. Differences Compared to Conventional VLIW Instructions
8.A. Architecture Characteristics
8.B. Advantages
   9. Further Examples

Detailed Disclosure

1. System Architecture

1.A. Overview

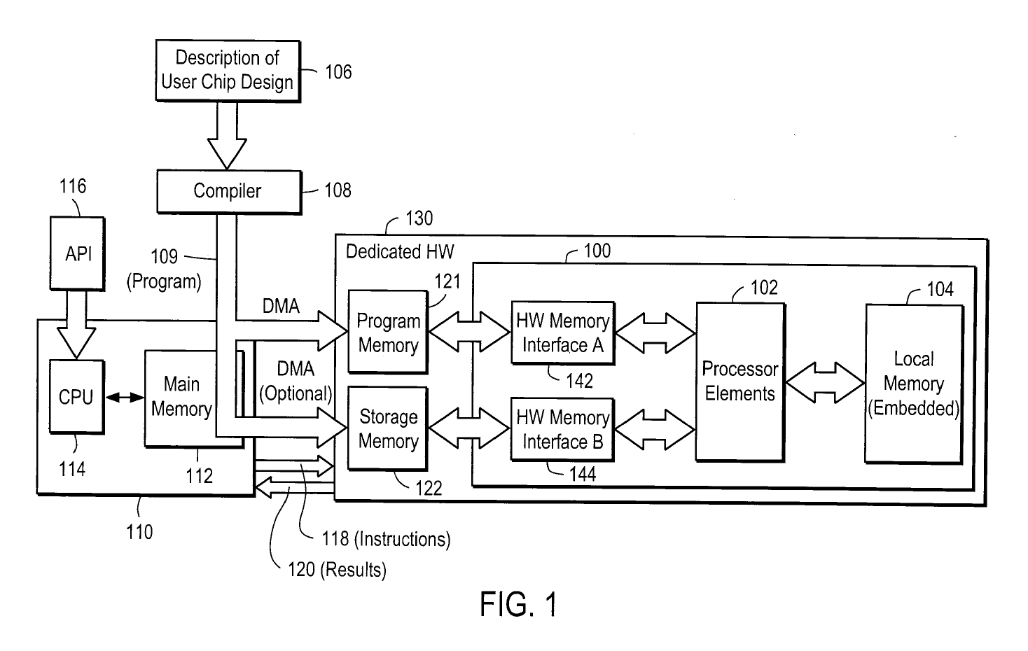

FIG. 1 is a block diagram illustrating a hardware accelerated logic simulation system according to one embodiment of the present invention. The logic simulation system includes a dedicated hardware (HW) simulator 130, a compiler 108, and an API (Application Programming Interface) 116. The host computer 110 includes a CPU 114 and a main memory 112. The API 116 is a software interface by which the host computer 110 controls the hardware simulator 130. The dedicated HW simulator 130 includes a program memory 121, a storage memory 122, and a simulation processor 100 that includes the following: processor elements 102, an embedded local memory 104, a hardware (HW) memory interface A 142, and a hardware (HW) memory interface B 144.

The system shown in FIG. 1 operates as follows. The compiler 108 receives a description 106 of a user chip or design, for example, an RTL (Register Transfer Language) description or a netlist description of the design. The description 106 typically includes descriptions of both logic functions within the chip (i.e., user logic) and on-chip memory (i.e., user memory). The description 106 typically represents the user logic design as a directed graph, where nodes of the graph correspond to hardware blocks in the design, and typically represents the user memory by a behavioral or functional (i.e., non-synthesizable) description (although synthesizable descriptions can also be handled). The compiler 108 compiles the description 106 of the design into a program 109. The program contains instructions that simulate the user logic and that simulate the user memory. The instructions typically map the user logic within design 106 against the processor elements 102 in the simulation processor 100 in order to simulate the function of the user logic. The instructions typically map user memory within design 106 against locations within the storage memory 122. The description 106 received by the compiler 108 typically represents more that just the chip or design itself. It often also represents the test environment used to stimulate the design for simulation purposes (i.e., the test bench). The system can be designed to simulate both the chip design and the test bench (including cases where the test bench requires blocks of user memory).

Further descriptions of example compilers 108, see U.S. Patent Application Publication No. US 2003/0105617 A1, “Hardware Acceleration System for Simulation,” published on Jun. 5, 2003, which is incorporated herein by reference. See especially paragraphs 191-252 and the corresponding figures. The instructions in program 109 are initially stored in memory 112.

The simulation processor 100 includes a plurality of processor elements 102 for simulating the logic gates of the user logic, and a local memory 104 for storing instructions and/or data for the processor elements 102. In one embodiment, the HW simulator 130 is implemented on a generic PCI-board using an FPGA (Field-Programmable Gate Array) with PCI (Peripheral Component Interconnect) and DMA (Direct Memory Access) controllers, so that the HW simulator 130 naturally plugs into any general computing system, host computer 110. The simulation processor 100 forms a portion of the HW simulator 130. The simulation processor 100 has direct access to the main memory 112 of the host computer 110, with its operation being controlled by the host computer 110 via the API 116. The host computer 110 can direct DMA transfers between the main memory 112 and the memories 121, 122 on the HW simulator 130, although the DMA between the main memory 112 and the memory 122 may be optional.

The host computer 110 takes simulation vectors (not shown) specified by the user and the program 109 generated by the compiler 108 as inputs, and generates board-level instructions 118 for the simulation processor 100. The simulation vectors (not shown) include values of the inputs to the netlist 106 that is simulated. The board-level instructions 118 are transferred by DMA from the main memory 112 to the program memory 121 of the HW simulator 130. The storage memory 122 stores user memory data. Simulation vectors (not shown) and results 120 can be stored in either program memory 121 or storage memory 122, for transfer with the host computer 110.

The memory interfaces 142, 144 provide interfaces for the processor elements 102 to access the memories 121, 122, respectively. The processor elements 102 execute the instructions 118 and, at some point, return simulation results 120 to the host computer 110 also by DMA. Intermediate results may remain on-board for use by subsequent instructions. Executing all instructions 118 simulates the entire netlist 106 for one simulation vector.

1.B. Simulation Processor

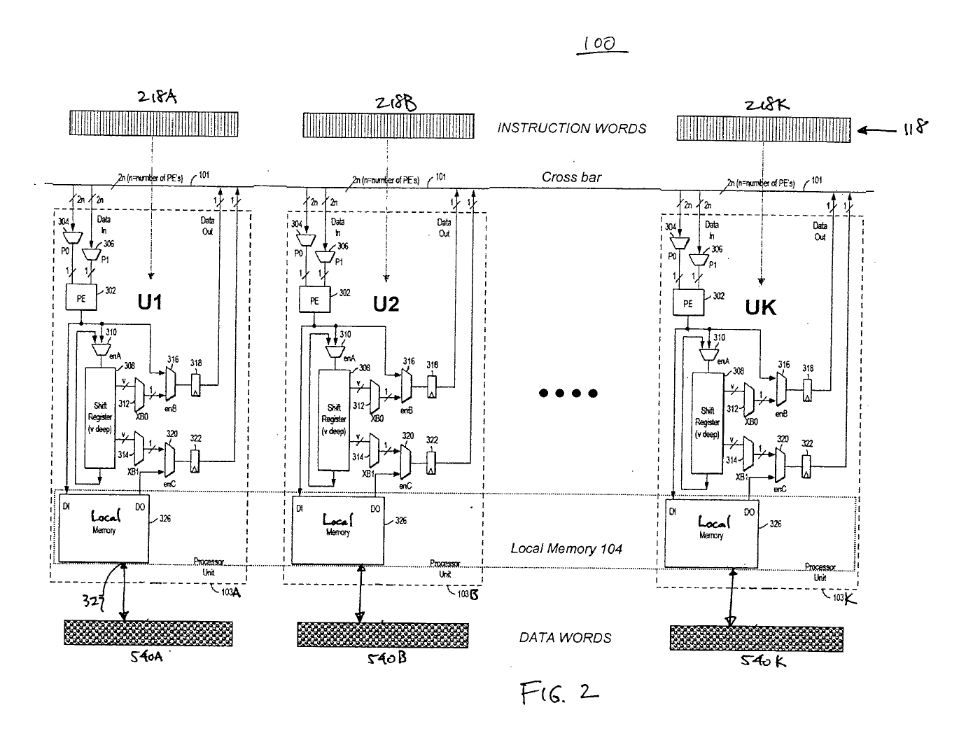

FIG. 2 is a block diagram illustrating the simulation processor 100 in the hardware-accelerated simulation system according to one embodiment of the present invention. The simulation processor 100 includes n processor units 103A-103K (also labeled U1, U2, . . . UK), that communicate with each other through an interconnect system 101. In this example, the interconnect system is a non-blocking crossbar. Each processor unit can take up to two inputs from the crossbar, so for n processor units, 2n input signals are available, allowing the input signals to select from 2n signals (denoted by the inbound arrows with slash). Each processor unit can generate up to two outputs for the crossbar (denoted by the outbound arrows). For n processor units, this produces the 2n output signals. Thus, the crossbar is a 2n (output from the processor units)×2n (inputs to the processor units) crossbar that allows each input of each processor unit 103 to be coupled to any output of any processor unit 103. In this way, an intermediate value calculated by one processor unit can be made available for use as an input for calculation by any other processor unit.

For a simulation processor 100 containing n processor units, each having 2 inputs, 2n signals must be selectable in the crossbar for a non-blocking architecture. If each processor unit is identical, each preferably will supply two variables into the crossbar. This yields a 2n×2n non-blocking crossbar. However, this architecture is not required. Blocking architectures, non-homogenous architectures, optimized architectures (for specific design styles), shared architectures (in which processor units either share the address bits, or share either the input or the output lines into the crossbar) are some examples where an interconnect system 101 other than a non-blocking 2n×2n crossbar may be preferred.

Each of the processor units 103 includes a processor element (PE) 302, a local cache 308 (implemented as a shift register in some implementations), and a corresponding part 326 of the local memory 104 as its dedicated local memory. Each processor unit 103 can be configured to simulate at least one logic gate of the user logic and store intermediate or final simulation values during the simulation. The processor unit 103 also includes multiplexers 304, 306, 310, 312, 314, 316, 320, and flip flops 318, 322. The processor units 103 are controlled by the VLIW instruction 118. In this example, the VLIW instruction 118 contains individual PE instructions 218A-218K, one for each processor unit 103.

The PE 302 is a configurable ALU (Arithmetic Logic Unit) that can be configured to simulate any logic gate with two or fewer inputs (e.g., NOT, AND, NAND, OR, NOR, XOR, constant 1, constant 0, etc.). The type of logic gate that the PE 302 simulates depends upon the PE instruction 218, which programs the PE 302 to simulate a particular type of logic gate.

The multiplexers 304 and 306 select input data from one of the 2n bus lines of the crossbar 101 in response to selection signals in the PE instruction 218. In the example of FIG. 2, each of the multiplexers 304, 306 for every processor unit 103 can select any of the 2n bus lines. If data is being read from the storage memory 122 rather than the crossbar 101, the multiplexers 304, 306 are activated to select the input line coming (either directly or indirectly) from the storage memory 122 (not shown in FIG. 2). In this way, data from the storage memory 122 can be provided to the processor units.

The output of the PE 302 can be routed to the crossbar 101 (via multiplexer 316 and flip flop 318), the local cache 308 or the dedicated local memory 326. The local cache 308 is implemented as a shift register and stores intermediate values generated while the PEs 302 in the simulation processor 100 simulate a large number of gates of the logic design 106 in multiple cycles.

On the output side of the local cache 308, the multiplexers 312 and 314 select one of the memory cells of the local cache 308 as specified in the relevant fields of the PE instruction 218. Depending on the state of multiplexers 316 and 320, the selected outputs can be routed to the crossbar 101 for consumption by the data inputs of processor units 103.

The dedicated local memory 326 allows handling of a much larger design than just the local cache 308 can handle. Local memory 326 has an input port DI and an output port DO for storing data to permit the local cache 308 to be spilled over due to its limited size. In other words, the data in the local cache 308 may be loaded from and/or stored into the memory 326. The number of intermediate signal values that may be stored is limited by the total size of the memory 326. Since memories 326 are relative inexpensive and fast, this scheme provides a scalable, fast and inexpensive solution for logic simulation. The memory 326 is addressed by fields in the PE instruction 218.

The input port DI is coupled to receive the output of the PE 302. In a separate data path, values that are transferred to local cache 308 can be subsequently moved to memory 326 by outputting them from the local cache 308 to crossbar 101 and then re-entering them through a PE 302 to the memory 326. The output port DO is coupled to the multiplexer 320 for possible presentation to the crossbar 101.

The dedicated local memory 326 also has a second output port 327, which can access both the storage memory 122 and the program memory 121. This patent application concentrates more on reading and writing data words 540 between port 327 and the program memory 121. For more details on reading and writing data words 540 to the storage memory 122, see for example U.S. patent application Ser. No. 11/292,712, “Hardware Acceleration System for Simulation of Logic and Memory,” filed Dec. 1, 2005 by Verheyen and Watt, which is incorporated herein by reference.

For further details and example of various aspects of processor unit 103, see for example U.S. patent application Ser. No. 11/238,505, “Hardware Acceleration System for Logic Simulation Using Shift Register as Local Cache,” filed Sept. 28, 2005; U.S. patent application Ser. No. 11/291,164, “Hardware Acceleration System for Logic Simulation Using Shift Register as Local Cache with Path for Bypassing Shift Register,” filed Nov. 30, 2005; U.S. patent application Ser. No. 11/292,712, “Hardware Acceleration System for Simulation of Logic and Memory,” filed Dec. 1, 2005; and U.S. patent application Ser. No. 11/552,141, “VLIW Acceleration System Using Multi-State Logic,” filed Oct. 23, 2006. The teachings of all of the foregoing are incorporated herein by reference.

1.C. PE Opcode

In this example implementation, the PE opcode 218 has the format:
P0|P1|EN|Boolean Func|XB0|XB1|XM

P0 and P1 are fields that determine which inputs from the crossbar 101 are selected by multiplexers 304 and 306, respectively, and input to the PE 302. Boolean Func determines the logic gate to be implemented by the PE 302. EN determines which inputs are selected by multiplexers 310, 316 and 320. XB0, XB1 and XM (Xtra Mem) are addresses. If multiplexers 316 and 320 are receiving data from the shift register (via multiplexers 312 and 314), then XB0 and XB1 are used as select inputs to multiplexers 312 and 314. If data is being loaded from or stored to local memory 326, then the relevant address in memory 326 is determined by the fields XB0, XB1 and XM.

In one approach, the EN field determines one of four operating modes for the PE 302: Evaluation, No-op, Load or Store. The primary function of Evaluation mode is for the PE 302 to simulate a logic gate (i.e., to receive two inputs and perform a specific logic function on the two inputs to generate an output). Accordingly, in this mode, the multiplexer 310 selects the output of the PE 302, multiplexer 316 selects the output of the multiplexer 312 and multiplexer 320 selects he output of the multiplexer 314, and XB0 and XB1 are used as inputs to multiplexers 312 and 314 (as addresses into the shift register 308). As a result, the PE 302 simulates a logic gate based on the input operands output by the multiplexers 304 and 306, stores the intermediate value in the shift register 308, which is eventually output to the crossbar 101 for use by other processor units 103. At the same time, multiplexers 312 and 314 can select entries from the shift register 308 for use as inputs to processor units on the next cycle.

In the No-op mode, the PE 302 performs no operation. The mode may be useful, for example, if other processor units are evaluating functions based on data from this shift register 308, but this PE is idling. In this mode, multiplexer 310 selects the last entry of the shift register 308, and multiplexers 316, 320 and XB0, XB1 are used the same as in the Evaluation mode (i.e., as inputs to multiplexers 312 and 314). During the No-op mode, the PE 302 does not simulate any gate, while the shift register 308 is refreshed so that the last entry of the shift register 308 is recirculated to the first entry of the shift register 308. At the same time, data can be read out from the shift register 308 via multiplexers 312 and 314.

The primary function of the Load mode is to load data from local memory 326. Here, the multiplexers are set so that data in the local memory 326 at the address determined by fields XB0, XB1 and XM can be loaded via multiplexer 320, and the PE 302 simultaneously performs a simulation based on the outputs from multiplexers 304 and 306. Note that during this mode, data can be loaded from the memory 326 to the crossbar 101 for use by processor units and, at the same time, the PE 302 can perform an evaluation of a logic function and store the result in the shift register 308. In many alternate approaches, evaluation by the PE and load from memory cannot be performed simultaneously, as is the case here. In this example, loading data from local memory 326 does not block operation of the PE 302.

The primary function of the Store mode is to store data to local memory 326. In this mode, the local memory 326 is addressed by fields XB0, XB1 and XM. Therefore, during the Store mode, the output of the PE 302 can be stored into the local memory 326. The Store mode is also non-blocking of the operation of the PE 302. The PE 302 can evaluation a logic function and the resulting value can be immediately stored to local memory 326. It can also be made available to the crossbar 101 via multiplexer 316.

One advantage of the architecture shown in FIG. 2 is that the Load and Store modes do not block operation of the PE 302. That is, the Load mode might be more appropriately referred to as a Load-and-Evaluation mode, and the Store mode might be more appropriately referred to as a Store-and-Evaluation mode. This is important for logic simulation. Logic simulation requires the simulation of a certain number of gates. Hence, the more quickly evaluations can be performed, the faster the logic simulation can be completed. Supporting load/store and evaluation in a single cycle is a significant speedup compared to approaches in which load/store requires one cycle and evaluation requires a separate cycle.

1.D. Event-Driven and Cycle-Based Simulators

A simulator can be event-driven or cycle-based. An event-driven simulator evaluates a logic gate (or a block of statements) whenever the state of the simulation changes in a way that could affect the evaluation of the logic gate, for example if an input to the logic gate changes value or if a variable which otherwise affects the logic gate (e.g., tri-state enable) changes value. This change in value is called an event. A cycle-based simulator partitions a circuit according to clock domains and evaluates the subcircuit in a clock domain once at each triggering edge of the clock. Therefore, event count affects the speed at which a simulator runs. A circuit with low event counts runs faster on event-driven simulators, whereas a circuit with high event counts runs faster on cycle-based simulators. In practice, most circuits have enough event counts that cycle-based simulators outperform their event-driven counterparts. The following description first explains how the current architecture can be used to map a cycle-based simulator and then explains how to implement control flow to handle event-driven simulators.

Typically, a software simulator running on the host CPU 114 controls which portions of the logic circuit are simulated by the hardware accelerator 130. The logic that is mapped onto the hardware accelerator 130 can be viewed as a black box in the software simulator. The connectivity to the logic mapped onto the hardware accelerator can be modeled through input and output signals connecting through this black box. This is modeled similarly for both internal and external signals, i.e. all internal signals (e.g. “probes”) are also brought out as input and output signals for the black box. For convenience, these signals will be referred to as the primary input (PI) and primary output (PO) for the black box. Note that this can be a superset of the primary input and primary output of a specific chip design if the black box represents the entire chip design. Usually, system task and other logic (e.g. assertions) are also included, and often, a part of the test bench is also included in the black box.

When any of the primary input signals changes in the software simulator, this causes an event that directly affects the black box. The software simulator sends the stimulus to the black box interface, which in this example is a software driver. The driver can send this event directly to the hardware accelerator, or accrue the stimulus. Accrual occurs when the hardware accelerator operates on a cycle-based principle. For synchronous clock domains, only events on clock signals require the hardware accelerator to compute the PO values. However, for combinational paths throught the design, any event on an input typically will require the hardware accelerator to compute PO values. The software driver in this case updates the PI changes and logs which clock signals have events. At the end of evaluation of the current time step, before the simulator moves to the next time step, the software driver is called again, but now to compute the PO values for the black box. This will be referred to as a simulaton event. Note that there will typically be only one simulation event per time-point, although it is possible for the software simulator to re-evaluate the black box if combinatorial feedback paths exist. At this point, the software driver is analyzing the list of the clock signals that have changed, and it directs the hardware accelerator to compute the new PO values for those domains. Other domains, for which the clocks did not change, typically need not be updated. This leads to better efficiency. To support combinational logic as well as clock domain interaction, a combinational clock domain is introduced which is evaluated regardless of clock events.

At each simulation event, the accrued changes are copied from main memory 112 into program memory 121, using DMA methods. After the DMA completes, a list of which clock domains and the sequence in which to execute them resides in the software driver. This list can be used to invoke the hardware accelerator 130 to update the POs for each clock domain, one domain at a time, or this list can be sent to the hardware accelerator in its entirety and have the hardware control routine execute the selected clock domains all at once, in a given sequence. Combinations hereof are also possible.

1.E. Clock Domains

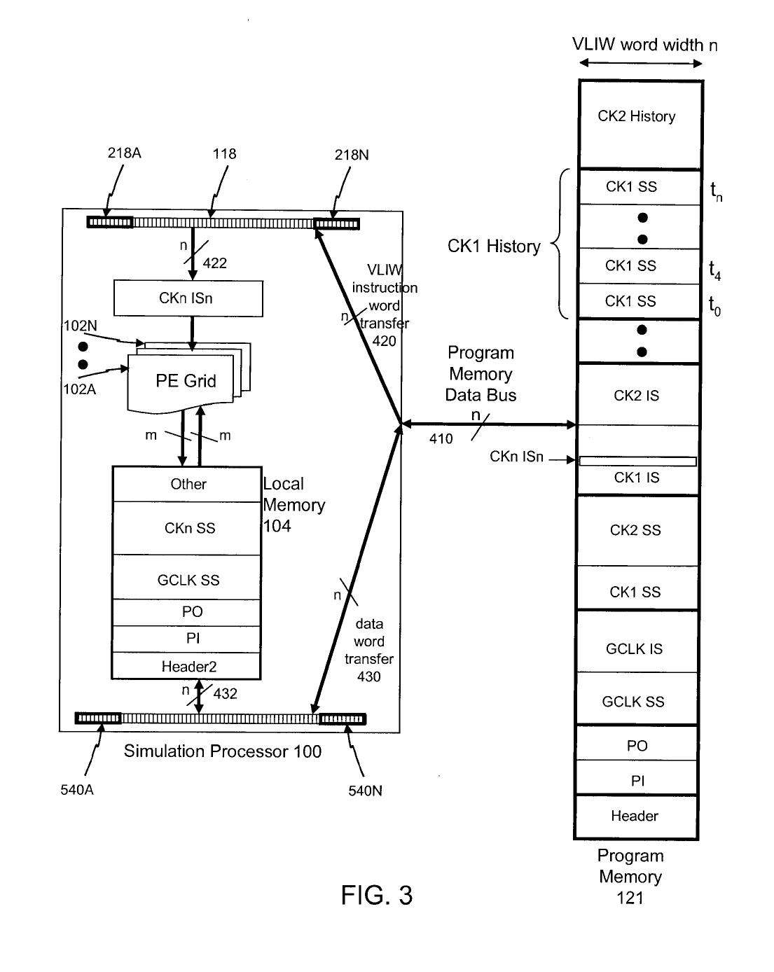

In one embodiment, the program memory 121 is arranged as depicted in FIG. 3. FIG. 3 is a diagram illustrating a memory arrangement of different domains by the simulation processor 100, according to one embodiment of the present invention. As mentioned above, executing all instructions 118 simulates the entire netlist 106 for one simulation vector. However, the entire netlist 106 typically is not loaded into local memory 104 and simulated all at once. Instead, the simulation typically is partitioned into different domains. Domains are then loaded into local memory 104 in sequence, and the entire netlist is simulated on a piecewise basis, one domain at a time.

FIG. 3 shows an example where the chip design is partitioned into clock domains, and the simulation is executed on a cycle-basis, one clock domain at a time. A single chip may use many clocks: clocks received from external sources, internally generated clocks and/or local clocks derived from any of these. Circuits in a chip design are in the same clock domain if events in the circuit are determined by the same clock. Inputs to a clock domain are synchronized to the clock for that domain, but can be sourced from other domains, as is common in gated clock domains. In the example of FIG. 3, the chip design is divided into a number of “local” clock domains, denoted by CK1, CK2, etc., and a global domain denoted by GCLK. The local clock domains are portions of the chip design that are evaluated upon a simulation event, or clock edge for that clock domain. The CK1 domain is timed by CK1 and the simulation of the circuits in the CK1 domain pertain to logic that depends only on clock CK1. Hence, these domains are “local.” The global domain GCLK contains portions of the chip design that overlap more than one clock domain, for example circuitry where timing is transitioned from one clock to a different clock, or a combinational path from primary inputs to primary outputs of a design, for example an asynchronous reset signal. The simulation of the circuitry affected by CK1 typically requires the simulation of the CK1 domain and the GCLK domain. For CK2, simulation of the CK2 domain and the GCLK domain typically is required, and so on. If CK2 was a gated clock domain of CK1, then CK2 would need to be evaluated whenever clock CK1 has an event and the gate logic enables CK2 causing CK2 therefore to also have an event. If CK1 and CK2 are asynchronous domains, they each would be evaluated when their events occur. The global GCLK domain is evaluated upon every event.

Information about the different domains is stored in the program memory 121. Each domain has an instruction set (IS) and a state space (SS). The instruction set is the group of instructions 118 used to simulate that domain. The state space is the current state of the variables in that clock domain. For convenience, the states spaces for the local domains CK1 SS, CK2 SS, etc. are stored together, as shown in FIG. 3. Similarly, the instruction sets for the local domains CK1 IS, CK2 IS, etc. are also stored together. The IS sets are instructions for each domain and they typically do not change during execution. Only one IS set is typically required for each SS, although multiple sets may be stored and selected by the hardware control routine. For instance, one SS may be accessed by several IS sets for clock evaluation, primary output evaluation, asynchronous set evaluation, asynchronous reset evaluation, assertion evaluation, or test code evaluation. The SS sets are data for each domain and they typically change each time the domain is evaluated. The SS sets are stored separately from the IS sets as there can be multiple instances of the SS sets, one for each time step in the simulation for that domain, allowing a history to be stored. In this example, the program memory 121 also includes the primary input (PI), primary output (PO) and a header. The primary input includes the stimulus vector. The primary output includes the response to the stimulus vector. The header can be further subdivided into separate headers that apply to each domain, and a global header that applies to the memory arrangement.

During simulation of a specific clock domain, the state space for the clock domain is stored in local memory 104 and the instructions 118 simulating the clock domain are fetched and executed. As shown in FIG. 3, the local memory 104 typically includes the state space of the local clock domain being simulated (CKn SS) and the state space of the global clock domain (GCLK SS). The local memory 104 may also contain PO, PI, (optionally) a header, and additional data such as temporary variables or local memory allocated for the simulation of user memory in the chip design.

During simulation, the instructions used to simulate the clock domain CKn (including the instructions for global clock domain GCLK) are fetched and executed by the PEs 102. FIG. 3 shows the fetch 410-420-422 of instruction CKn ISn from program memory 121 to the PEs 102. Execution of the instructions changes the state space. Once all instructions 118 for the clock domain have been executed, simulation of the clock domain for that time step is complete and the revised state space CKn SS is stored 432-430-410 back to program memory 121. The state space for the next clock domain to be simulated is loaded 410-430-432 into local memory 104 in preparation for simulation. This process repeats until simulation of the chip is completed. The same clock domain usually will be loaded into local memory 104 more than once to simulate different times.

2. Non-synthesizable Tasks

In this implementation, a program counter (PC) register points to an address in program memory 121 and, upon a read instruction, data streams from program memory 121 over program memory data bus 410 into the PE instruction register array 118. Each next clock cycle, the PE instruction register array is refreshed. The PE instruction register array operates in lieu of an instruction cache. The instructions are fetched each cycle from program memory, so the VLIW simulation processor has, in effect, no on-chip instruction cache or, alternatively, a very large, off-chip instruction cache.

The VLIW architecture based solely on processor elements 102 is an efficient approach to executing programs 109 (and the tasks within description 106), if the tasks can be simulated by the processsor elements and if the instructions in program 109 can be scheduled in an efficient predetermined manner at compile time (e.g., no dynamic JUMP instructions). However, for more complex descriptions 106, this often is not the case. Rather, the tasks represented in the description 106 can usually be classified as either synthesizable or non-synthesizable. Generally, synthesizable tasks are tasks which can be efficiently mapped to the processor elements 102.

In the logic simulation example of FIG. 1, user logic is typically a synthesizable task because it reflects logic that is meant to go in-circuit and is normally synthesized. The processor elements 102 are specifically designed to simulate the logic operations of such user logic. On the other hand, many behavioral models, such as user memory models, many test bench functions (such as initial, repeat, forever, unbounded loops, event, real, time, fork, join, procedural assignments, certain operators) and overall control of the simulation (such as #delay, incomplete sensitivity lists, non-local reference, behavioral control) typically are non-synthesizable tasks and are not meant to go in-circuit. These typically are more efficiently handled by portions of the simulation system other than the processor elements 102 (e.g., by the host computer 110, by the storage memory 122 or by exception handlers within the system). See, for example, IEEE 1364 and 1076 Synthesis Interoperability Standards for Verilog and VHDL, respectively, which are incorporated herein by reference, for further discussion and examples. In addition, more complex programs 109 often will require more complex types of dynamic, or runtime control, realized through branching.

The execution of non-synthesizable tasks can be efficiently accomplished via exception handlers. An exception handler is a technique that can be used to handle a task which cannot be done directly by the processor elements 102 or can be done more conveniently or faster externally. An exception handler takes input data and computes output data based on a described protocol or algorithm, which can be re-entrant (preserves internal states). In traditional CPU architectures, a floating point co-processor can be viewed as an on-chip exception handler. U.S. patent application Ser. No. 11/292,712, “Hardware Acceleration System for Simulation of Logic and Memory,” filed Dec. 1, 2005 by Henry T. Verheyen and William Watt illustrates how a behavioral user memory description can be handled in hardware using an exception handler. It also illustrates how multi-cycle evaluations can be added to a single cycle VLIW processor.

Domains can be used to help implement branching. In domains, tasks or instructions to be executed are grouped together into domains. These domains can be roughly categorized into two types: control domains and execution domains. A control domain is a domain which sequences (schedules) various other domains. For example, in U.S. patent application Ser. No. 11/296,007, “Partitioning of Tasks for Execution by a VLIW Hardware Acceleration System,” the hardware control routine is applied to dynamically schedule clock domains. Control domains differ from execution domains in that, when connecting control domains, context switching typically is required (i.e., the state space typically is swapped in and out); whereas when connecting execution domains, this typically is not the case and the domain operates within a single state space. The clock domain instruction sets (CK IS) as described in U.S. patent application Ser. No. 11/296,007 are examples of execution domains.

The current disclosure explains how execution domains can be constructed out of multiple groups of Instruction Sets (IS). The execution domains themselves can be organized in the VLIW architecture to allow dynamic sequencing of IS groups within the execution domain itself, rather then returning to the control domain to select the next IS group. An execution domain is a portion of a domain in which computations are performed. Execution domains can invoke other execution domains, either as a sequence (next domain) or as a child domain. Execution domains allow larger domains to be subdivided into smaller groups. This can simplify the implementation of branching. Domains can also be constructed in a hierarchical manner.

3. Exception Handlers

3.A. Extended Architecture

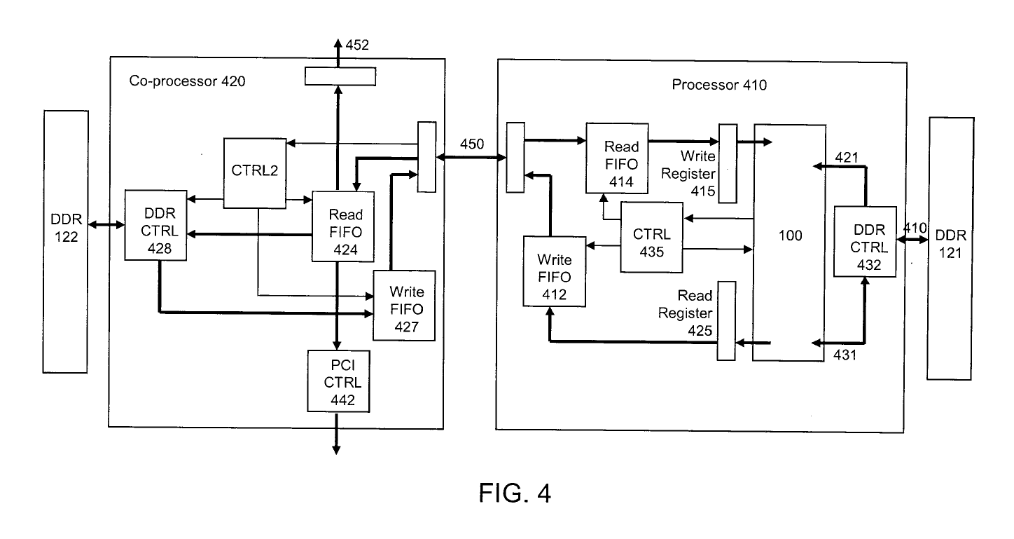

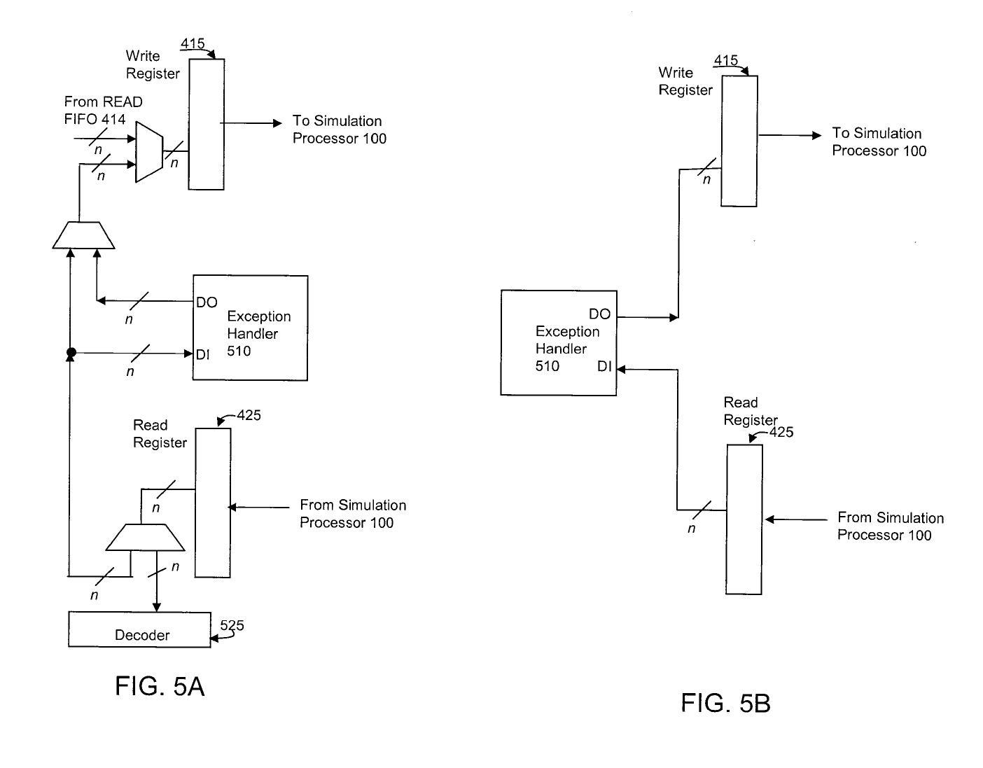

FIGS. 4-5 illustrate architectures for implementing exception handlers. FIG. 4 is a block diagram of a specific implementation of interfaces between the simulation processor 100 and the program memory 121 and storage memory 122. This particular example is divided into a processor 410 and co-processor 420, each with its own read FIFOs, write FIFOs and control. The two parts 410 and 420 communicate to each other via an intermediate interface 450. Although this division is not required, one advantage of this approach is that the design is modularized. For example, additional circuitry on the co-processor 420 can be added to introduce more functionality. The same thing can be done for the processor 410.

The interface in FIG. 4 operates as follows. Instruction fetches from the program memory 121 occur via path 411-432-421 to instruction registers in the simulation processor 100. Data reads from the program memory 121 to the simulation processor 100 (e.g., loading a new state space) occur via path 411-432-431. Data writes from the simulation processor 100 to the program memory 121 (e.g., writing back a revised state space) occur via the reverse path 431-432-411.

Reads and writes from and to the storage memory 122 occur through the processor 410 and co-processor 420. For a write to storage memory, the storage memory address flows from read register 425 to write FIFO 412 to interface 450 to read FIFO 424 to memory controller 428. The data flows along the same path, finally being written to the storage memory 122. For a read from storage memory, the storage memory address flows along the same path as before. However, data from the storage memory 122 flows through memory controller 428 to write FIFO 427 to interface 450 to read FIFO 414 to write register 415 to simulation processor 100.

The operating frequency for executing instructions on the simulation processor 100 and the data transfer frequency (bandwidth) for access to the storage memory 122 generally differ. In practice, the operating frequency for instruction execution is typically limited by the bandwidth to the program memory 121 since instructions are fetched from the program memory 121. The data transfer frequency to/from the storage memory 122 typically is limited by either the bandwidth to the storage memory 122 (e.g., between controller 428 and storage memory 122), the access to the simulation processor 100 (via read register 415 and write register 425) or by the bandwidth across interface 450.

In one implementation designed for logic simulation, the program memory 121 and storage memory 122 have different bandwidths and access methods. The program memory 121 connects directly to the main processor 410 and is realized with a bandwidth of over 200 billion bits per second. Storage memory 122 connects to the co-processor 420 and is realized with a bandwidth of over 20 billion bits per second. As storage memory 122 is not directly connected to the main processor 410, latency (including interface 450) is a factor. In one specific design, program memory 121 is physically realized as a reg [2,560] mem [8M], and storage memory 122 is physically realized as a reg [256] mem [125M] but is further divided by hardware and software logic into a reg [64] mem [500M]. Relatively speaking, program memory 121 is wide (2,560 bits per word) and shallow (8 million words), whereas storage memory 122 is narrow (64 bits per word) and deep (500 million words). This should be taken into account when deciding on which on which DMA transfer (to either of the program memory 121 and the storage memory 122) to use for which amount and frequency of data transfer.

Interface 442 (shown as a PCI interface in this example) can be used to transfer data back to the host computer 110 via path 425-412-450-424-442. Interface 452 allows expansion to another card. Data, including state space history, can be transferred to the other card for additional processing or storage. In one implementation, this second card compresses the data. An analogous approach can be used to transfer data from other cards back to the co-processor 420.

3.B. Loopback Exception Handlers

FIGS. 5A and 5B are block diagrams illustrating exception handlers. In FIG. 5A, an exception handler 510 is inserted in a loopback path from the read register 425 to the write register 415. For direct loopback, data transfers from the read register 425 directly to the write register 415. On the alternate path, data transfers from the read register 425 to the exception handler 510 to the write register 415. The exception handler can handle many different functions and may have other ports, for example connecting to other circuitry, processors, or data sources/sinks. FIG. 5B shows an alternate architecture, in which interactions with the read register 425 and write register 415 are handled by the exception handler 5 10. The direct loopback path from read register 425 to write register 415, the interactions with storage memory 122, etc. are all handled through the exception handler 5 10.

The exception handler 510 typically is a multi-bit in, multi-bit out device. In one design, the exception handler 510 is implemented using a PowerPC core (or other microprocessor or microcontroller core). In other designs, the exception handler 510 can be implemented as a (general purpose) arithmetic unit. Depending on the design, the exception handler 510 can be implemented in different locations. For example, if the exception handler 510 is implemented as part of the VLIW simulation processor 100, then its operation can be controlled by the VLIW instructions 118. Referring to FIG. 2, in one implementation, some of the processor units 103 are modified so that the PE 302 receives multi-bit inputs from multiplexers 304, 306, rather than single bit inputs. The PE 302 can then perform arithmetic functions on the received vector data.

In an alternate approach, the exception handler 510 can be implemented by circuitry (and/or software) external to the VLIW simulation processor 100. For example, referring to FIG. 4, the exception handler 510 can be implemented on circuitry located on 410 but external to the simulation processor 100. One advantage of this approach is that the exception handler 510 is not driven by the VLIW instruction 118 and therefore does not have to operate in lock step with the rest of the simulation processor 100. In addition, the exception handler 510 can more easily be designed to handle large data operations since it is not directly constrained by the architecture of the simulation processor.

3.C. Opcodes for Invoking Exception Handlers

The instruction set for the simulation processor 100 can be designed so that certain opcodes invoke an exception handler. Referring to Section 1.C., one possible opcode format is
P0−P1|EN|Boolean Func|XB0|XB1|XM
Exception handlers could be triggered by a special P0/P1 field overload on PE0. In one implementation, if PE0 receives an instruction with EN indicating the No-op mode and P0=P1=0, then an exception handler is triggered. Other instructions can also be used to trigger exception handlers. If an exception handler is triggered, the remaining fields in the opcode could be interpretted differently to more specifically identify the exception handler. The instruction set could also be designed so that, upon an exception handler trigger, the opcodes from other PEs are also used to identify the exception handler. In another implementation, the fields XB0, XB1, XM can be interpetted as pointing to a location in local memory 326, with that location either containing additional information about the exception handler or containing a longer address (e.g., in storage memory 122) that contains additional information about the exception handler. Other approaches to invoking and specifying exception handlers will be apparent.

3.D. On-chip Based, On-PCB Based, Host CPU Based and Host Program Based Exception Handlers

For the following description, exception handlers are categorized into four different groups: On-chip Based, On-PCB Based, Host CPU Based and Host Program Based. “On-chip Based” means the exception handler executes concurrently with the processor cycle inside the VLIW processor 100 integrated circuit (chip). Typically, the exception handler does not complete its computation within a single processor cycle and may use different methods to access the data in comparison to the processing elements 102. An example is a floating point calculation, assuming that the processing elements 102 do not handle floating point arithmetic. Another example is a processor core, such as the PowerPC core, which can be embedded in the same chip as the VLIW processor 100 as an exception handler. Special functions that complete within a single VLIW processor cycle but require hardware assist (i.e. they are executed outside the grid of processing elements) are also considered to be part of this class. Examples of the last group can include implementations of the conditional branch [“if(expression)”] and hardware assisted assertions [“has_x_or_z(expression)”]. The conditional, unconditional, and multi-way branch instructions introduced below can also be implemented using this category of exception handler.

“On-PCB Based” means the exception handler is off-chip with respect to the VLIW simulation processor 100, but is executed elsewhere on the same printed circuit board (PCB) card, or daughter card thereof, that hosts the VLIW processor. The PowerPC core-based exception handler can be On-PCB Based if implemented in a semiconductor chip separate from the VLIW processor 100.

“Host CPU Based” refers to exception handler activity that is performed on the host computer 110. Examples of this typically relate to file I/O, such as (in simulation) messaging ($display), or input data ($readmemh), or output data (VCD/FSDB dump). Files are accessible through the operating system and therefore are executed on the host computer. Typically, these access methods can be performed in the driver software that links the VLIW simulation processor 100 to the host CPU 114.

“Host Program Based” refers to an exception handler that is implemented as a software program, other than the driver software, which executes on the host CPU and to which program the VLIW processor 100 is a child process (in certain architectures). There may be no such process, e.g. when the VLIW processor 100 is executed directly from the host CPU 110. In simulation of the design of semiconductor integrated circuits, the host program typically refers to a software simulator and this program can maintain certain state machine elements such as $time, $realtime, foreign PLI functions, library methods, etc., which are only defined within the scope of the simulation program. Exception handlers that use access to or from these variables typically are executed inside the software simulator. Generically, a program may be partitioned such that a portion executes on the host 110 (like the simulator program) and a portion on the VLIW processor card 130.

3.E. Behavioral Primitives and Embedded Behavior

Since, for certain applications, the VLIW processor 100 is designed primarily to handle synthesizable tasks, exception handlers may be used frequently to handle non-synthesizable tasks. In the context of simulation of integrated circuits, non-synthesizable tasks are often referred to as behavioral or functional tasks (referring to tasks that can be described in terms of behavior or function but which are difficult to synthesize into an equivalent logic circuit). Behavioral tasks can generally be classified into two groups: Behavioral Primitives and Embedded Behavior. A Behavioral Primitive (BP) is a behavioral task that is implemented by an On-chip Based exception handler or by On-PCB Based exception handler. An Embedded Behavior (EB) is a behavioral task that is implemented by a Host CPU Based exception handler or by a Host Program Based exception handler.

Behavioral Latency is one attribute of behavioral tasks. Depending on how an exception handler is modeled, the time to compute the desired response (i.e., the behavioral latency) can vary widely. For example, On-chip Based exception handlers can respond very fast. The basic conditional branch [“(if expression)”] test-condition responds within a single VLIW instruction cycle. The same branch implemented by an internal loop-back exception handler (as shown in FIG. 5) may respond in 10 VLIW instruction cycles. On-PCB Based exception handlers typically require higher latency before the data can be produced, e.g. 100 VLIW instruction cycles for user memory operations. On-chip Based and On-PCB Based microprocessor (e.g. Power PC core) based exception handlers may respond in milliseconds, corresponding to multi-100s of VLIW instruction cycles. Host CPU Based and Host Program Based exception handlers may take even longer, upwards of 1,000s of VLIW instruction cycles.

4. Branching

4.A. JUMP Opcodes

Referring to FIG. 3, a program counter (PC) register points to an address in program memory 121 and, upon a read instruction, data streams from program memory 121 over program memory data bus 410 into the PE instruction register array 118. Each next clock cycle, the PE instruction register array is refreshed. Hence, a JUMP can be implemented by loading the PC register with a new address for program memory 121, which causes the VLIW instruction to continue reading from this new address upon the next instruction word fetch. This can be done without a hiatus in the instruction stream and is efficient in implementation.

Referring to Section 1.C. above, the opcode format for the VLIW simulation processor 100 introduced there is
P0|P1|EN|Boolean Func|XB0|XB1|XM
JUMP instructions can be encoded as follows. The fields P0 and P1 determine the two inputs to the PE 302, and the field Boolean Func determines the function to be simulated by the PE 302. In this example, BUF (buffer) is chosen as one of the possible Boolean Func's. However, BUF only requires one input (say the P0 input). This leaves P1 available to encode special values, which will be referred to as “overloads.” In one implementation, JUMP commands are included as part of this set of overload operations (note that exception handlers could also be implemented this way). Hence, if a PE 302 encounters Boolean Func=BUF and P1=JUMP overload value, it interprets the instruction as a JUMP command.

More than one JUMP command can be included as part of the instruction set. The following is an example set of six JUMP commands, each of which would correspond to a different overload value for P1

Unconditional JUMPG

Conditional JUMPG

Unconditional JUMPR forward (increment)

Conditional JUMPR forward (increment)

Unconditional JUMPR backward (decrement)

Conditional JUMPR backward (decrement)

Where JUMPG is a global jump (i.e., jump to an absolute address) and JUMPR is a relative jump (i.e., increment or decrement the current PC register by the indicated amount). Unconditional jump occurs all the time. Conditional jump occurs is the condition is satisfied. Conditional jump can be implemented, for example, by pre-computing the condition and using the P0 field to indicate whether the condition is TRUE or FALSE.

In the case of JUMPG, the address field may be longer than the PE opcode. In that case, the additional bits needed to complete the opcode can be obtained in a number of ways. In one approach, the address field may be completed using opcodes from other PEs. For example, if XB0, XB1 and XM together have 16 bits but the PC register has 24 bits, the additional 8 bits could be taken from the XB0, XB1 and/or XM fields of the adjacent PE. Indirection can also be used. For example, XB0, XB1 and XM may point to a location which contains a 24 bit address (or which itself points to a 24 bit address), although indirection usually adds latency to executing the JUMP instruction.

In the case of JUMPR, the maximum increment can be limited to what is available in the current opcode. This approach avoids the complexity of locating the extra bits from somewhere else. Continuing the above example, JUMPR may be limited to 16 bits. That is, the PC register can be incremented or decremented by a maximum of 16 bits, rather than the entire span of 24 bits.

The approach described above is an efficient branching mechanism for the VLIW processor, based on the PE opcode. The branch requires only a single PE (for appropriately limited JUMPR) or a single PE, combined with bit fields of its adjacent PE (for JUMPG). In addition, the branching can be made conditional on dynamic expressions (i.e., computed at run-time), which allows any expression to be created for the test-condition of the conditional branch. Because the VLIW simulation processor is instruction cache-less, the branch can be performed with almost no penalty. In contrast, in VLIW processors with instruction caches, branching can require the instruction cache to be purged and reloaded, which is inefficient.

In addition, in this example, the VLIW processor 100 is implemented as a single integrated circuit and all PEs 302 have access to the on-chip memory. As a result, any expression can be stored anywhere in the chip and be used as the test condition in a conditional branch. The test can be evaluated with effectively no penalty since evaluation is already designed to be part of normal operation of the VLIW processor.

4.B. Latency

In the VLIW architecture described above, the instruction word is continuously streamed in from off-chip memory 121 and, after a jump, all processing elements 302 receive new instruction data from the instruction word located at the new JUMP address. Branching, by means of the JUMP instruction, is therefore done for all processing elements simultaneously (This can be refined, for example by parallel threading, as described in further detail below). JUMP instructions are performed in a single VLIW instruction cycle, but may carry latency, usually only a few instruction cycles, depending on the memory architecture. If so, the VLIW processor may remain inactive until the instructions starts streaming from the JUMP address. A further optimization is to use delayed branching, i.e. allowing branch delay slots (allow the VLIW processor to compute during the extra instruction cycles, essentially absorbing the latency, so no VLIW instruction cycles are lost).

For example, if the memory latency is four instructions, the jump is executed four instruction cycles after the VLIW instruction word which has the JUMP instruction in it (delayed branch), as shown below. During these four instructions, the VLIW can continue the execution cycle, but preferably no other JUMP instructions can be scheduled in these four instruction cycles, as it would interfere with the already initiated JUMP instruction. Also, the first valid return-address is technically not the address directly following the VLIW instruction which has the JUMP instruction, but this address +four (in case latency is four).

| 010001: JUMP 020000 | // executed at t = 0 |
|---|---|
| 010002: . . . | // executed at t = 1 |
| 010003: . . . | // executed at t = 2 |
| 010004: . . . | // executed at t = 3 |
| 010005: . . . | // first valid return location |
| 010006: . . . | // code continues |
| 020000: . . . | // executed at t = 4 |

Put in another way, the VLIW instruction words streaming into the VLIW processor are chronologically as follows: |010001|010002|010003|010004|020000|020001|020002. The stream is continuous, there is no hiatus. The latency is known a priori and can be accounted for in scheduling. In this disclosure, it will be assumed that the memory latency is zero for purposes of clarity of the discussion and examples.

4.C. Stackless and Stacked Operation

In a simplified embodiment, recursion is not allowed. Therefore, an execution domain, once active, cannot be invoked again. This simplifies bookkeeping greatly. There is no need for a stack mechanism and handling of temporary data. All variables are accessible globally (within the clock domain) and jumps can be performed at will.

The approach is also simplified by hard-coding return addresses. Rather than dynamically jumping and pre-loading an expected return address, all the jump addresses are statically computed, except for certain operations (which will be explained later). This enables the maintenance of the “read” mode from the program memory 121, which is preferable for certain applications.

A branch instruction which dynamically pushes the desired return address can also be implemented. The stack formed by branching can be kept in a local memory, as each return address requires only the number of bits in the program counter register. This memory is small and can be implemented, for example, as a FIFO inside the state machine that handles the VLIW word load 420 and be kept outside the PE grid. Stacked operation will be described further below.

4.D. Domain Implementation using Branching

As described previously, a larger program can be divided into domains. Domains can be “assembled” together into the larger program via branching. Three ways to enter a domain are forward jump, side-entrance jump and return. Forward jump is a jump to the beginning of a domain. Side-entrance jump is a jump to the middle of a domain. A return instruction is a special case of the side-entrance jump, which allows execution domains that were invoked from a calling domain to return to this domain, either before (while looping) or after (if branching) the point of invocation.

Side-entrance jumps are somewhat more complex than forward jumps. In this particular application, since the scheduler is scheduling operations in parallel, there may already be start computations (logic cones in simulation) that have not yet been completed at the jump point. In a forward jump, the computation can continue, as the status of all the temporaries (both in the shift registers 308 and local memory 326) is known. In fact, if multiple forward jumps exist, each forward jump can simply continue the computation of these parallel operations.

However, when the scheduler schedules a side-entrance jump (or return), the invoked domain will have used the temporary data space and the shift register may now be in an unknown state. The parent domain may not know how many clock cycles have passed nor whether temporary data remains valid.

In one approach, the scheduler simply invalidates the temporary data, resulting in reloading of temporaries for the parent domain and re-computing the parallel operations that were already being scheduled. This typically is not a great cost, as most variables will be loaded into the temporary storage only when needed (dependent driven late loading). This is in fact similar to how a processor would operate if it has no stack. Its pre-loaded registers are the only ones available and must be reused during the processing of the invoked child function and, therefore, the content of the registers becomes invalidated upon return, requiring the processor to reload the registers once the child function completes.

In an alternative approach, the invoked domain is not allowed to remove any temporaries from the shift registers. It must preserve them. Nor is it allowed to reuse the scratch pad already in use. It must use empty slots. This usually makes the invoked domain slightly less efficient than an unrestricted domain would be and is more workable for smaller, rather than larger, domains. If so, the invoked domain does not disturb the temporary data space of the parent domain. It merely affects the location the shift registers are left in when the invoked domain completes. Then, after completion, the parent domain rotates the shift registers by as many cycles as are needed to put them back identically to the state they were in when the child domain was invoked. The number of empty cycles involved here is at most equal to the depth of the shift registers and may or may not be more efficient than the invalidation step.

Depending on the program or design (netlist) being mapped, either or both approaches can be used. Usually, the invalidation approach is more efficient for larger invoked domains and the preservation approach is more efficient for smaller invoked domains.

In a third approach, the shift registers can be replaced by static registers. As this requires additional programming bits (in the PE opcode 218), the amount of static registers will be less than the amount of shift registers for a similar PE opcode size. This approach has as a benefit that return instructions do not require the special handling that the first two approaches require, at the cost of fewer storage registers.

Returning to the approach using shift registers, if the temporary variables are preserved, a stack mechanism can be implemented. In the VLIW architecture, there can be many temporary values, so the stack size could be rather large, as the stack must maintain both the return address and all the local (temporary) variables. It can be realized using the shift register 308 and local memory 326, but this limits the space available especially for deeper levels of invocation (or recursion). In a simpler approach, the domains that are invoked using a stack push-pop mechanism would be restricted from using the shift registers 308. Instead, they operate directly on actual and temporary variables loaded and stored from memory 326, which restricts scheduling efficiency, but also limits the size of the stack. Memory 326 can then be arranged such that a new data space is made available for local (temporary) variables at each level of recursion, effectively supporting the push and pop mechanisms associated with a stack.

The end of an execution domain typically will have an unconditional branch. Preceding the unconditional branch, a conditional branch can be used, which allows the execution domain to continue at two, or more, different locations, depending on the test conditions. An example is given below (assuming zero latency):

| 010122: . . . | // last code in execution domain |
|---|---|
| 010123: if ( COND1 ) JUMP 020000; // conditional branch | |
| 010124: if ( COND2 ) JUMP 030000; // 2^{nd} conditional branch | |
| 010125: JUMP 040000 ; | // unconditional branch |
| . . . | |
| 020000: . . . | // jumped to if COND1 |
| . . . | |
| 030000: . . . | // jumped to if COND2 and !COND1 |
| . . . | |

040000: . . . // unconditional (!COND1 and !COND2)

4.E. Some Examples

For simplicity, assume no recursion and only global variables. As an example, consider a simple if-then-else construct, using an invoked child execution domain:

Parent Execution Domain:

010001: if ( COND ) JUMP 020000 ; // to child execution domain

| | |
|---|---|
| 010002: . . . | // code continues, this is the else branch |
| . . . | |
| 010010: . . . | // last of the else branch instructions |
| 010011: . . . | // side-entrance (return) address |

Child Execution Domain:

| | |
|---|---|
| 020000: . . . | // code continues, this is the if branch |
| . . . | |
| 020009: . . . | // last of the if branch instructions |

020010: JUMP 010011: // (i.e. return jump)

To make any address (in parent or child, child being the parent to another child), returnable (i.e., to give it the side-entrance designation), no hardware support is required. The only implication is that the software scheduler does reset its usage of temporary variables at this address, or restricts temporary usage in the invoked domains (or uses a stack).

The following alternative example shows the same if-then-else code mapped in the parent domain, similar to single processor scheduling, but in this case for a VLIW, using an in-lined execution domain:

010001: if ( COND ) JUMP 010040; // conditional jump to if branch

| | |
|---|---|
| 010002: . . . | // code continues, this is the else branch |
| . . . | |
| 010038: . . . | // last of the else branch instructions |

010039: JUMP 010060 ; // unconditional jump past if branch

| | |
|---|---|
| 010040: . . . | // code continues, this is the if branch |
| . . . | |
| 010059: . . . | // last of the if branch instructions |
| 010060: . . . | // side-entrance location |

A similar construct can be used to implement a loop:

| 010001: . . . | // beginning of the loop |
|---|---|
| 010002: if ( !COND ) JUMP 010040; // if COND then exit loop | |
| 010003: . . . | // code continues, this is the loop body |
| . . . | |
| 010038: . . . | // last of the loop body |
| 010039: JUMP 010001 ; // repeat loop | |
| 010040: . . . | // code continues |

4.F. Multi-way Branch and Control Variable Analysis

One advantage of the VLIW simulation processor is that the VLIW instruction word can be so large that multi-way branches can be encoded as a single instruction (or a number of instructions that is fewer than the number of branches). For example, consider a case statement, which can be viewed as a sequence of conditional branches:

```
case (a) {
    0:  JUMP ADDR0 ;  // if(0) ? goto ADDR0
    1:  JUMP ADDR1 ;  // if(1) ? goto ADDR1
    2:  JUMP ADDR2 ;  // if(2) ? goto ADDR2
    3:  JUMP ADDR3 ;  // if(3) ? goto ADDR3
    . . .
    N:  JUMP ADDRN ;
}
```

This requires N conditional branch instructions.

With a multi-way branch instruction this can be implemented as a single instruction:
010001: case (a): 0?ADDR0; 1?ADDR1; 2?ADDR2; . . . ; N?ADDRN;
010002: . . . ://next instruction address, e.g. a return, or side-entrance location
Recall that each PE 302 receives an opcode. Each of the conditional branch instructions can be evaluated by a different PE 302, but all of the evaluations can occur simultaneously (i.e., in the same clock cycle), allowing for k parallel branches if there are k processor elements. Alternatively, a parallel decoder can be used to decode the entire branch instruction and allow bit-packing for even higher efficiency by eliminating the opcode for all but one PE.

The multi-way branch is not only a technique that allow the compiler to handle complex control flow graphs, but is also a technique that can be used to optimize the execution speed. That is, function can be compiled multiple times, each time with different assumptions. In logic simulation, if variables change at a low frequency, their related logic does not need to be computed each time. In statically scheduled VLIW execution, the system functions as a cycle simulator and automatically computes all variables at each cycle. If an execution domain can assume that variables are either 1 or 0, the domain execution can be trimmed, based on this knowledge. This reduces the amount of compute steps and the related savings can be significant. Typically, control variables that control if-then-else or case-statements can eliminate large logic computations (logic cone) if it is known during compilation that their value is constant. Example techniques include Constant Propagation (CP) and Dead Code Elimination (DCE). A domain that would require 50,000 cycles may reduce to 25,000 cycles if certain variables were constant.

In simulation, this assumption cannot be made, but the compiler could schedule multiple domains. For example, assume three variables A, B and C, and the following table:

| ID | A | B | C | # Cycles |
|---|---|---|---|---|
| 0 | — | — | — | 65,000 |
| 1 | FALSE | FALSE | FALSE | 15,000 |
| 2 | FALSE | FALSE | TRUE | 25,000 |
| 3 | FALSE | TRUE | FALSE | 50,000 |
| 4 | FALSE | TRUE | TRUE | 45,000 |
| 5 | TRUE | FALSE | FALSE | 55,000 |
| 6 | TRUE | FALSE | TRUE | 42,000 |
| 7 | TRUE | TRUE | FALSE | 60,000 |
| 8 | TRUE | TRUE | TRUE | 12,000 |

Further, assume that the domain, without special consideration for the control variables, requires 65,000 cycles (ID 0 in the table).

Note that IDs 1, 2 and 8 yield significant savings. Rather than compiling the execution domain as a single 65,000 cycle domain and rather than compiling this as eight separate domains (one for each ID), the compiler might create four execution domains: 0, 1, 2, and 8. If, during simulation execution the combination of the control variables occurs that is listed in the table under ID 1, 2 or 8, acceleration is achieved by using the alternate execution domain. In all other cases, ID 0 (i.e. the non-optimized execution domain) assures correct evaluation.

Another way of viewing these domains is that these domains may be optimized for different purposes—and under dynamic control. For example, controls can be used to trigger self-checking domains (assertions), or debug domains (producing visibility). The controls can be user selected at run-time, or may be generated from within the executed logic itself In this case, the multiple domain generation is not for acceleration purposes, but for debug or visibility purposes. Other variations will be apparent.

This technique can be optimized for multiple control variables. For example, if 16 control variables were analyzed, there would be 65,536 possible alternate execution domain variants. As an example, allowing up to 16 control variables uses 4 bit wide conditional evaluations, coupled with the JUMPG requiring 24 bits (assuming a PC address for 16M VLIW words) or the JUMPR requiring 16 bits (assuming as described above). This results in either 4+24=28 or 4+16=20 bits per branch target. A special overload opcode is used to trigger the (hardware based—parallel engine) conditional branch jump instruction inside the first PE—PE0 overload. This uses 7 bits. Assuming 64 PEs with 40 bits per PE instruction 118 yields 2560 bits for the VLIW instruction 118. This allows for (2560−7)/28=91 JUMPG or (2560−7)/20=127 JUMPR to be bit packed in a single VLIW instruction 118. Other variations will be apparent.

Thus, out of the group of 65,536 possible alternates, up to 91 domains can be selected within a single VLIW instruction cycle using the global jump (and up to 127 using the relative jump). The program code for 91 execution domains is significantly larger than the program code for a single execution domain, so this should be taken into consideration. Program memory 121 is rather large and the instruction domain is available in its entirety, regardless of the program size—the compiler can optimize the execution time by generating more execution domain variants as long as program memory 121 has space available. This allows a derating-versus-speedup trade-off. Higher capacity at a given speed; lower capacity at an increased speed.

5. Complex Execution Domains

5.A. Non-Synthesizable Tasks and Branching

The exception handling and branching techniques described above enable the logic simulation system to handle non-synthesizable tasks in an efficient manner. Conventional VLIW processors are efficient at computing synthesizable tasks in a predetermined order. If the tasks are independent, they can be executed in parallel. If the order of execution can be determined at compile time (e.g., does not depend on dynamic branch conditions), the tasks can be scheduled back-to-back to most efficiently use the VLIW computing resources.

However, conventional VLIW processors typically lose efficiency if the order of execution cannot be determined at compile time. The selection of a branch at run-time may require purge of the instruction cache and/or data cache. If the caches are deep, this purge and reloading for the correct branch may take a significant number of cycles, during which the VLIW computing resources may be idling. Furthermore, the introduction of non-synthesizable tasks further reduces efficiency. In some cases, conventional VLIW architectures simply do not handle non-synthesizable tasks. In other cases, non-synthesizable tasks are completed by resources other than the VLIW processor elements. However, a mix of synthesizable tasks and non-synthesizable tasks requires communication and coordination between VLIW processor elements and non-VLIW processor resources, and this can have significant latency. Furthermore, additional inefficiency may be introduced if the VLIW processor must idle while waiting for results from a non-synthesizable task.

In contrast, in the VLIW implementation described above, both branching and non-synthesizable tasks can be handled efficiently. For branching, the overall program can be divided into domains, with efficient VLIW computation within a domain and efficient branching between domains (or even between different locations within the same domain) as described previously. Traditional inefficiencies such as purging the instruction cache are avoided since, in this case, there is no instruction cache. Within a domain, non-synthesizable tasks can be implemented efficiently by exception handlers, as described previously, as opposed to either forcing the VLIW processor elements to handle the non-synthesizable task in an inefficient manner or simply not supporting the execution of non-synthesizable tasks. An exception handler may take some time to execute (e.g., depending on memory latency) but this time often can be calculated a priori (i.e., at compile time) and then accounted for in the scheduling of tasks so that VLIW processor idling is reduced or eliminated. In addition, the architectures and approaches described above also reduce the communication overhead required to coordinate between VLIW processor elements and non-VLIW processor resources.

5.B. Example Execution Domains

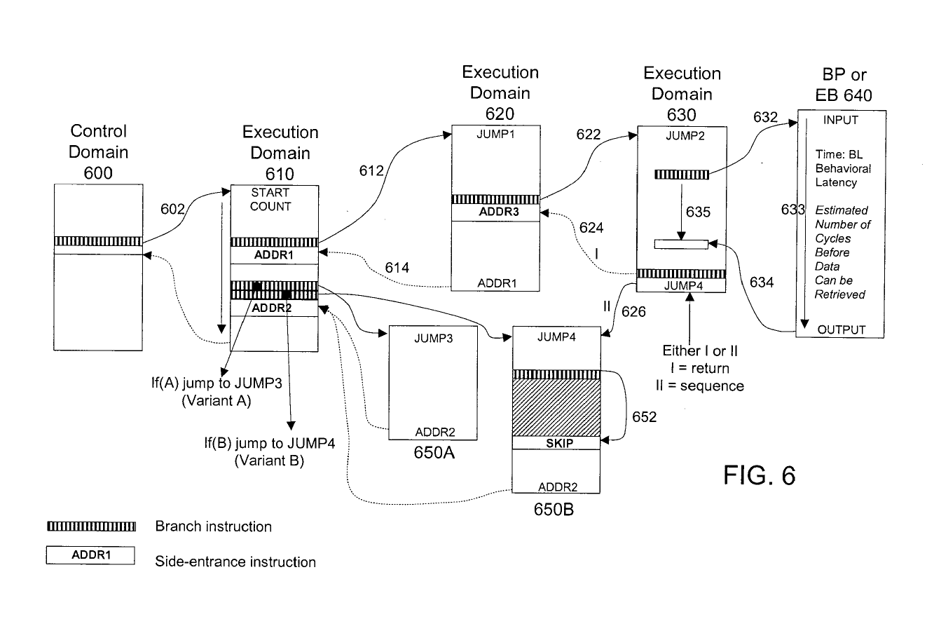

FIG. 6 is a diagram illustrating an example organization of execution domains. This example is chosen in order to illustrate various features. The top-level domain is control domain 600. The control domain 600 invokes 602 the parent execution domain 610 with a forward jump to START COUNT (rather than with a side-entrance jump). A branch (conditional or unconditional) at the parent execution domain 610 then jumps 612 to address JUMP1, which is a forward jump to execution domain 620. Similarly, another branch makes another forward jump 622 to address JUMP 2 (execution domain 630).

An exception handler 640 is initiated 632 within execution domain 630. The exception handler 640 can be either a behavioral primitive or an embedded behavior. In either case, the exception handler 640 requires some time to execute 633, which is the behavioral latency of the exception handler. This latency typically can be estimated at compile time so that the earliest time of return 634 can also be estimated and scheduled appropriately. In the meantime, execution domain 630 can have the VLIW processor continue to execute 635 tasks (including possibly initiating other exception handlers) so that compute resources are used efficiently. Note that the VLIW simulation processor can execute 635 in parallel with execution 633 of the exception handler.

In this example, execution domain 630 ends by returning 624 to ADDR3 within execution domain 620. The default ending of execution domain 630 is an unconditional branch 626 to JUMP 4 (execution domain 650B). Execution domain 620 returns 614 to ADDR1 of execution domain 610.

Another feature shown in execution domain 610 is alternate execution domains, aka code replication. In this case, the parent 610 has two conditional jumps, one to variant 650A and one to variant 650B. The two execution domains 650A and 650B are mapping the same region of the program or design (netlist), but are optimized for different behavior (e.g., see Section 4.F. above). For example, one domain 650 may have debug routines ($display active) or use assertions while the other domain may sidestep this. Another use of this feature is to enable state dependent optimization as described above. Another example is large multiplexing on bussed signals. Variant 650A might be optimized to remove the multiplexers (dead-code-elimination-DCE) given certain conditions. If the conditions are not met, variant B is the correct domain to be executed. Switching happens dynamically and enables additional performance improvements. Controlling which domain is executed can be done using the “if(expression)” in which the which the expression can be any method by which the data can be dynamically obtained. In this example, both variants 650A and 650B return to ADDR2 within domain 610.

Another feature shown in domain 650B is the forward skip 652. This is a jump within the domain that skips over a piece of code that would otherwise have to be executed (e.g. “if(! cond)jump SKIP;”—equivalent to “if(cond) execute if-body;”). This is often referred to as in-lining of code. The VLIW architecture can support similar mechanisms as exist for single processors using the JUMP instruction. This is another form of the side-entrance jump highlighting that this is not restricted in how it is used.

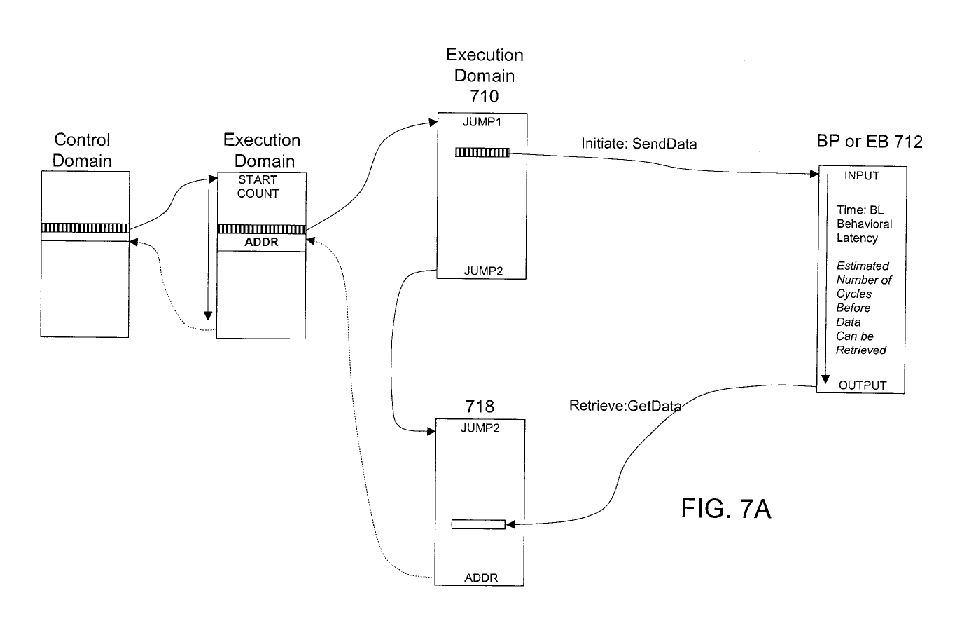

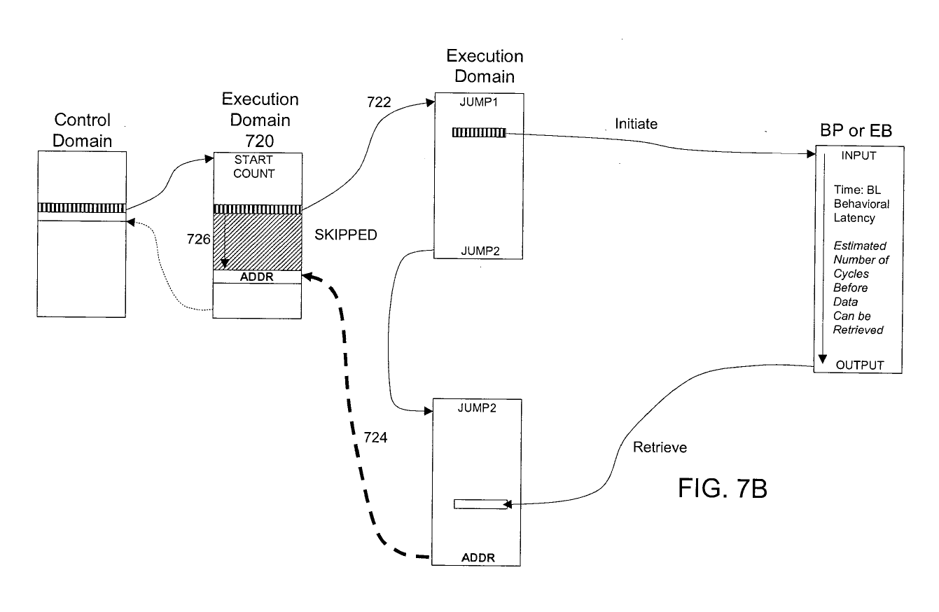

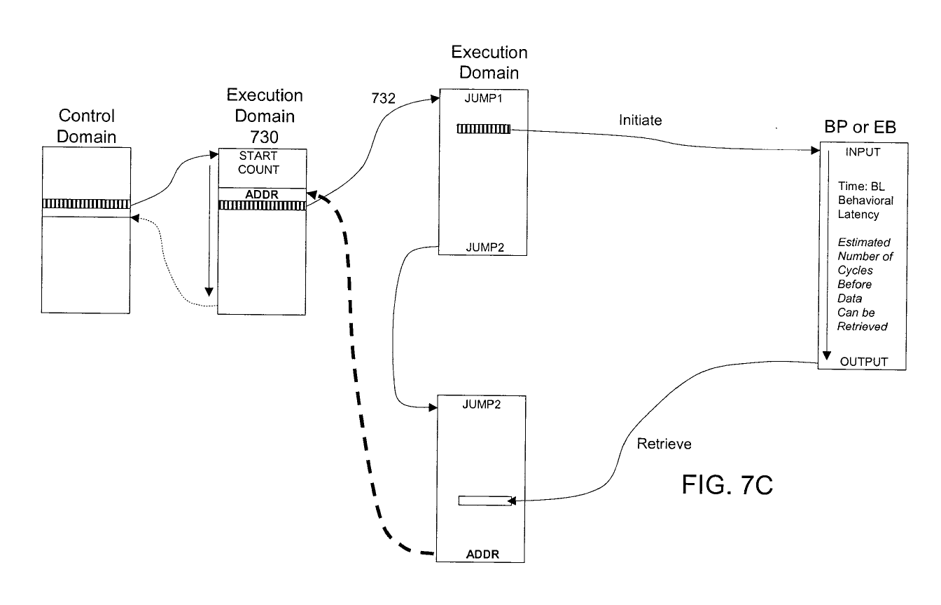

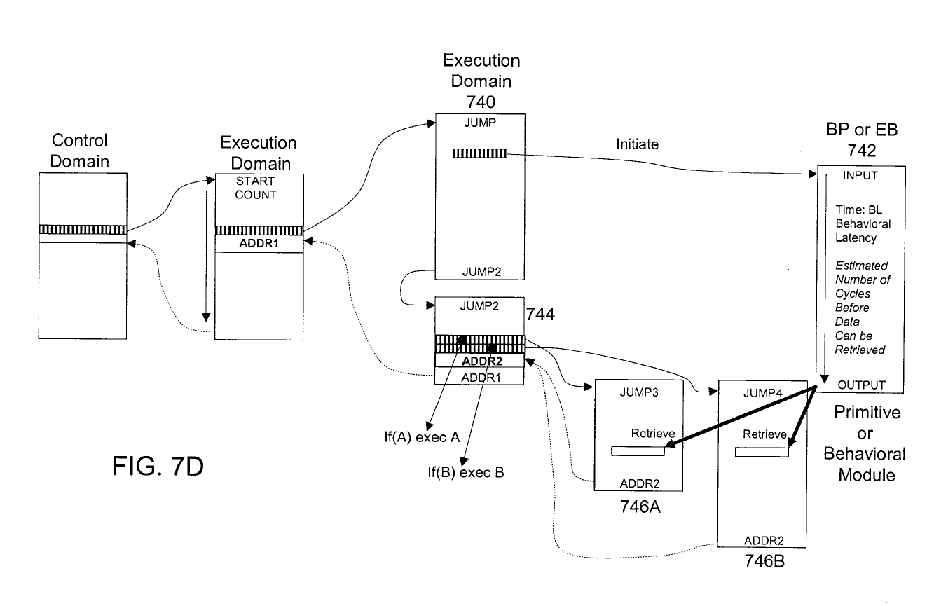

FIGS. 7A-7D give additional examples of various features. FIG. 7A expands on the exception handler with high behavioral latency. It is not required that the same execution domain that initiates the exception handler also retrieves the data. In FIG. 7A, domain 710 initiates the exception handler 712 and domain 718 receives the result. Some exception handlers do not have a retrieve (GetData) component, e.g. a $display( ) or $mem_write( ) operation. Others, such as $mem_read( ) or $readmemh( ) do. If they do, the data retrieval can be scheduled when ready, which may be in a very different execution domain. The software scheduler keeps track of all already initiated requests that have a data retrieval component, and schedules them consistent with their behavioral latencies. This feature is a strong component in creating larger execution domains, which are preferred for higher efficiency instruction level parallelism in VLIW scheduling.

FIG. 7B expands on the side-entrance/return mechanism. A branch 722 is initiated from domain 720. However, the return is not to the immediately next address. Rather, the return 724 is to a later address (ADDR field). This highlights the flexibility of the scheduler, and shows yet another if-then-else construct. The if-branch jumps 722 to address JUMP1, schedules the exception handler and returns 724 to address ADDR. The else-branch does not jump to JUMP 1. Rather, it keeps computing 726 in the parent domain 720. This structure is useful for larger domains that can be scheduled (compiled) in parallel using multiple computers (hierarchical scheduling).

FIG. 7C shows a similar construct, but now applied to looping. The loop test is the conditional branch. If !COND, then execution jumps 732 to JUMP1. Otherwise, the loop completes and execution continues in the rest of domain 730.

FIG. 7D expands on code replication. In this example, domain 740 invokes the exception handler 742. Execution continues in parallel within domain 740 and then domain 744 and then either domain variant 746A or 746B. In this case, both variants 746A and 746B depend on data retrieval from the exception handler. They both schedule the Retrieve instruction and observe the behavioral latency. In this case, neither 746A nor 746B is in-lined. The use of exception handler 742 allows this task to be separated from execution domains 746A/B.

5.C. Example Clock Domain Organization

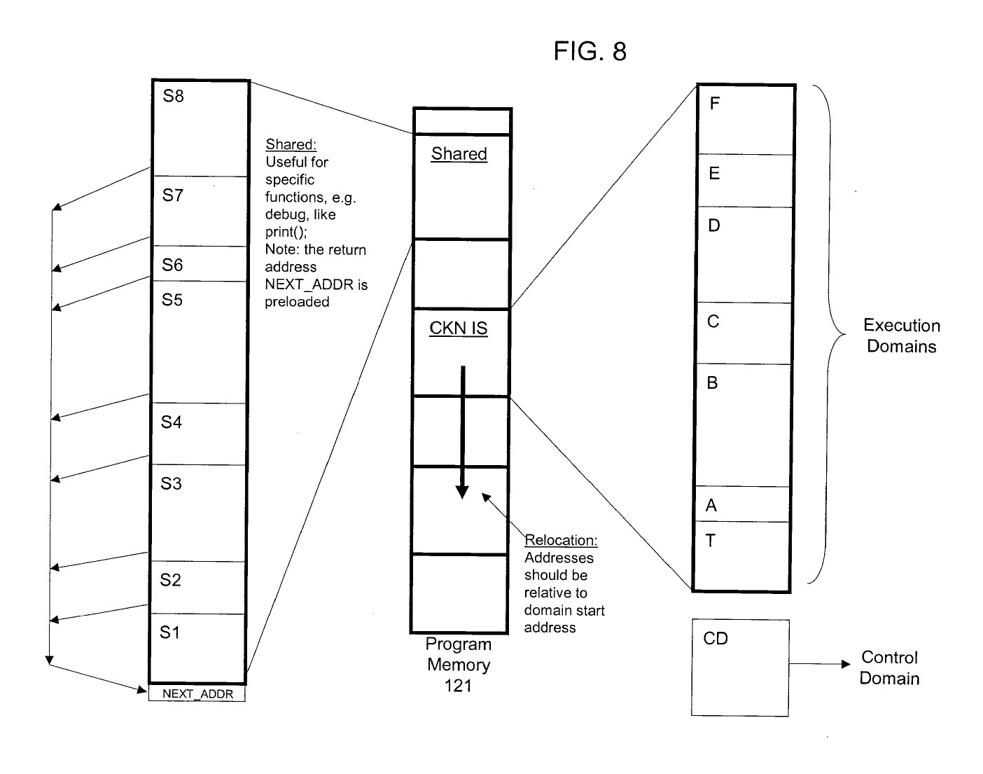

Referring to FIG. 3, FIG. 3 shows how clock domains can be organized within the program memory 121. FIG. 8 shows how execution domains can be organized within a clock domain. The clock domain organization shown on the right side of FIG. 3 is reproduced in the middle of FIG. 8. The right side of FIG. 8 shows how clock domain CKN is broken up into execution domains. Domain T is the top execution domain, i.e. the first domain invoked from the control domain CD. Domains A-F are the other execution domains. Note that the control domain may invoke multiple execution domains. There is no requirement that each execution domain be limited to a single top domain.

FIG. 8 also shows how the CKN instruction domain can be relocated. Assume that all the JUMP instructions within the CKN domain are relative, and need no adjustment. Only JUMP instructions that go outside the CKN domain (JUMPG) need be recalculated. This is useful for code-reuse. In the context of simulation for circuit designs, this is beneficial because, if the circuit design is used multiple times, the corresponding execution domains can also be re-used. Furthermore, the execution domains do not need to be recompiled upon re-use and can therefore be encrypted and protected.

FIG. 8 also shows a shared library that is of a global nature, with execution domains S1-S8. For example, this library can contain pre-compiled exception handlers that can be executed as execution domains. Usually these are used when debugging the scheduler, or the run-time, as it can be used to dump out pre-selected values and addresses. For simplicity, a single address, marked by NEXT_ADDR, is highlighted to which each of the shared functions jump to. To return to a specific address in the clock domain CKN, this address NEXT_ADDR is overwritten with the desired return address. Note that this structure is repeated for each group of shared modules, as only one can be active in this particular example. Multiple modules can be constructed if they need to be active simultaneously.

Furthermore, the NEXT_ADDR field can be stored in on-chip memory, rather than in the off-chip memory (program memory 121). This avoids having to write in the program memory 121 during execution, which would be less efficient. This is referred to this as an indirect jump. Handling of the indirect jump is done through the VLIW state machine controller, not the PE instruction. The NEXT_ADDR field is a reserved address that triggers the state machine to lookup the actual next address from on-chip memory. The actual next address is written into either automatically or programmatically. Automatically means that when invoking the S1-S8 domains, the next address in the program counter memory is automatically stored in the on-chip memory. Programmatically means under program instruction. For example, a new special “overload” PE instruction can be added that stores a compiler generated address (global or relative) in this on-chip memory. The automatic method enables an automatic jump-return, whereas the programmatic method enables a jump address to be selected for continuation.

6. VLIW Compilation and Scheduling

6.A. Overview

VLIW scheduling can be done cyclic or acyclic. Cyclic schedulers operate on loops in the program and acyclic schedulers operate on loop-free regions. A region is a group of execution domains that can be entered from the top and, unlike traditional VLIW architectures, the current architecture also allows side-entrances to the region. A “return” statement—i.e. looping within the region using side-entrances—is also possible under certain restrictions that stem from the VLIW architecture and not from the program (or netlist) scheduled. Region formation affects the efficiency of scheduling. Compiler techniques can be used to enlarge regions, which generally results in more efficient scheduling. For example, a technique named “loop unrolling” can be applied to convert a loop in the program into a loop-free region, which allows an acyclic scheduler to operate on the loop. The current architecture generally allows arbitrary region size, which is a significant advantage both for logic simulation and for general programming applications (see Section 9 below).

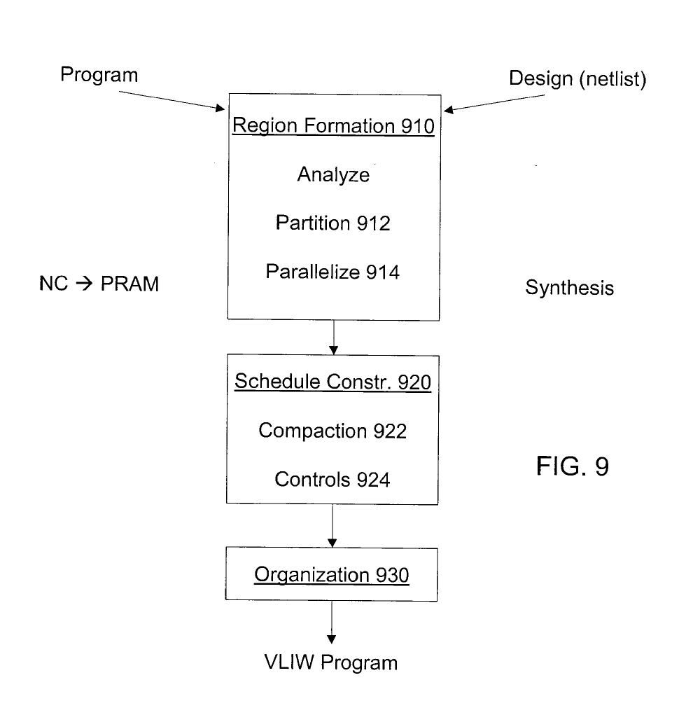

As shown in FIG. 9, VLIW scheduling generally includes these steps: region formation 910 and schedule construction 920. Region formation 910 includes partitioning 912 the program/design into regions and parallelizing 914 the execution of instructions in the region. Schedule construction 920 includes compacting 922 the scheduling for the region (i.e., scheduling the program/design) and connecting 924 the regions in the program/design (i.e., add the control logic).

In traditional VLIW scheduling, common regions include the following. A “basic block” is a single entry, single exit, no branching block. The program enters from the top and exits at the bottom with no branching allowed. A “trace” is a single entry, single exit block formed by unrolling as much code as possible and taking most likely to occur branches. A “superblock” is a single entry, multiple exit, no internal branching (i.e., looping) block. The program enters from the top and can jump back to the top at the end of the block, allowing branching outside the superblock. A “hyperblock” is a single entry, multiple exit, internal branching allowed block. Essentially a superblock with internal branching control, usually using if-conversion. (In logic mapping, this is how most mux logic is mapped, unless the cone feeding into the mux is large). A “treegions” is a single entry, multiple exit, internal branching allowed block. Each treegion is identified as a collection of basic blocks, with the property that each basic block has exactly one predecessor within the region. This results in any path through the treegion forming in a superblock (no side-entrances). “Tail duplication” is also a common enlargement technique to avoid side-entrances.

However, in the VLIW approach described above, two additional features have been introduced: side entrance jump into a region and the exception handler. As a result, the ability to create regions is not limited to the common set of VLIW regions listed above. Because of these two additional features, efficiency can be greatly enhanced compared to traditional VLIW region formation and scheduling techniques.

In traditional VLIW, once the regions are formed, each region is scheduled for ILP (instruction level parallelism). Duplicated regions may exist (tail duplication) or regions may have been formed using if-conversion techniques. However, in the current architecture, the region formatter can have greater flexibility than in traditional VLIW. In essence, region formation is making tradeoffs between schedule instructions and control instructions. Referring to FIGS. 6-7, schedule instructions can be visualized as the execution domains and the control instructions can be visualized as the various jump instructions (if-then-else, case, for, while, etc.).

In traditional VLIW scheduling, control instructions cause the regions to break into multiple, smaller regions (e.g., to avoid cache coherency issues). However, it is generally desirable to increase the size of regions in order to increase computational efficiency for VLIW scheduling. In contrast, under the current architecture, the VLIW processor reads each instruction directly from off-chip memory. Since the instruction cache has been eliminated (and therefore also the cache coherence problem), this allows scheduling of jumps from one execution domain to another execution domain with almost no cost. In other words, VLIW efficiency does not depend as much on the size of the execution domain. A region can be made up out of many execution domains. In this case, the path through the execution domains, the trace, can be dynamically adjusted to only execute the trace that, under dynamic control, happens to be activated. All other traces are not executed.

Traditional trace-based VLIW scheduling is efficient when the predicted trace is executed, but less efficient when the non-predicted trace is in use. If a trace includes 10 if-then-else decision points, and each decision has a 90% yes chance and a 10% no chance, then the statistical chance of a successive 10-yes trace is only (0.9)¹⁰, or 35%. To replicate a trace for each of the other possible traces, which have lower statistical chance of occurring, tail duplication is needed which can increase the instruction code by a factor of almost two for each level of tail duplication, resulting in large code overhead. In contrast, in the current VLIW architecture, each if-then-else trace can be linked to provide the correct sequence, with no code duplication and no execution overhead. The efficient implementation of jumps obviates the need for creating regions limited to the aforementioned conventional techniques -trace, superblock, hyperblock, treegions.

6.B. Region Enlargement

Since VLIW efficiency is related to the size of regions, region enlargement techniques preferably are used to increase the size of regions. One such technique is loop unrolling, which essentially in-lines the loop body. Another such technique is trace scheduling, in which the most common traces are pre-computed, resulting in a loop-free region for each of the pre-computed traces. This allows faster execution for these traces. A “generic” region handles the more cumbersome, loop-invoking scheduling, which likely executes slower (for “all-other-traces”). This can be done on both a granular and larger scale basis. Another such technique is tail duplication, in which the region has traces that share similar endings. In this case, the end code is shared, only the code needed for the tails are required. If-conversion is a technique in which both branches of the if-then-else are evaluated and only one of the results is taken forward, but can now be statically scheduled. This reduces the number of possible branches at the expense of extra (unnecessary) compute time.

However, other region enlargement techniques, which are not necessarily applicable to traditional VLIW scheduling, can be used as the number of processing elements in the VLIW processor grows. Generally, enlargement techniques enable higher VLIW efficiency, such as loop unrolling. However, with a large number of processors, it is sometimes better to compute both expressions of an if-then-else construct (if-conversion), rather than jumping to an if- or else-execution domain (control flow mapping). In some cases, if basic block jumping and branching were scheduled, full efficiency of the VLIW processor may not be reached.

Three specific examples of enlargement techniques are loop unfolding, if-then-else conversion and exception handlers. Loop unfolding is a more general case of loop unrolling. Loop unrolling is straightforward, but can only be done when all variables are known and bound. In the case this is not true, loops can still be unfolded using more elaborate schemes. Examples include loop peeling, loop unfolding, quasi invariant/index variables and unfolding factors.

If-then-else conversion is the execution of both answers and then selection of the desired one. In chip logic, this is referred to as a MUX operator and the two inputs can be seen as the if- and else-branches. The selector selects which value is taken.

For exception handlers, execution domains can initiate an exception (BP or EB) that produces results to be handled later on. In this technique, such data can be retrieved in a different execution domain, and this is a powerful method to simplify the VLIW schedule and reduce the control flow graph (CFG).

The multi-way jump is a specific BP for case statements that can be used to convert a case statement into a control statement and vice versa. A case statement in a synthesizable construct can be synthesized (unfolded) and fully executed inside a single execution domain. The benefit of handling the case statement as a control statement allows the compiler to schedule the various case evaluation execution domains independently, so only the execution domain that needs to be evaluated is active. Hence performance is improved. The benefit of handling the case statement as an unfolded execution domain is that the case statement logic can be scheduled in overlay with other logic, and requires no special handling. Naturally, in this solution, all possible case cases are evaluated, not only the one that is active. The active one is the propagated forward into the receiving logic. The compiler analyzes the size of each of the cases, and if large, favors the multi-way jump, and if small, favors the unrolled approach.

This description illustrates that the compiler can create arbitrary regions. The compiler preferably has the options to allow control insertion (JUMP) and removal (unfolding), to allow entrance into a domain at the side (NEXT_ADDR, SKIP_ADDR), to allow conditional branching with zero or little overhead (single cycle “if(expression)” evaluation) and to allow exception handlers of varying types that can be used to schedule varying latency operators, access slow interfaces (e.g. file I/O), or simply handle code that cannot be unrolled otherwise.

6.C. In-lined, Invoked or Unrolled, including Dynamic Conditions

Typically, large parallel operations are invoked, whereas small operations are unfolded. Unfolded operations can both improve (loop unrolling) and reduce the overall VLIW efficiency (if-conversion: extra unnecessary operations may be scheduled) but this is compensated for in that, by creating larger regions, the VLIW packing is increased. The following is an example of a common code structure:

| | |
|---|---|
| functionA (var, i) { | |
| for( ; i < 10 ; i ++ ) | // i is dynamic, not known statically |
| var = functionB ( var ) ; | // subroutine call |
| } | |
| functionB (b) { | // subroutine function |
| b = b * 2 ; | |
| return b; | // body of functionB |
| } | |

Depending on language and applications, bodies of subroutines can generate large execution blocks, e.g. for wide logic (64 bit, 128 bit) and complex operations.

In-lined code involving looping uses jumps within the execution domain, but subroutine jumps can be avoided. The above example can be in-lined as follows:

```
functionA ( var, i ){
    for(; i < 10 ; i ++ )
        var = var * 2 ;  // content (body) of functionB
}
```

In-lining does not resolve the jumping (looping), but it does avoid the subroutine call by replacing the function call with the body of the subroutine. Doing so enlarges the code but avoids the function stack call. Depending on code and application this may have a positive trade-off. The following is another in-lined example. The number on the left is assumed to be the memory address of the PC (program counter) register. Comments are given at the right hand side.

| | |
|---|---|
| 010000: . . . | // previous code block |
| 010001: if ( i>=10 ) JUMP 010005; | // side-entrance address, test for end loop |
| 010002: var = var * 2 ; | // function B execution domain code |
| 010003: i = i + 1; | // update variable i |
| 010004: JUMP 010001; | // end: jump to side-entrance location |
| 010005: . . . | // code continues, loop completed |

This approach eliminates the call into functionB altogether, but it does not eliminate branching. The for-loop execution still requires a branching instruction. Note that the fact that variable i is not known at compile time (dynamic variable) is not a limitation, but it requires a JUMP on both addresses 010001 and 010004, whereas if i was known, only a JUMP would be needed in address 010004. Similarly, if the end condition (10 in this case) was also dynamic, the code example would still apply, even if the end condition was subject to change during the execution of the body.

Unrolled code is code which is fully expanded. Unrolling a loop is only possible if it can be statically (i.e., at compile time) determined how many iterations there are. In the example given (where i is dynamic), the loop cannot be unrolled. However, if i was assigned within functionA, e.g.
i=0;

then there is a bounded loop. for (i=0; i<10 ; i++) is executed exactly (statically determined) 10 times. The code can be unrolled and this results in the body of function to be instanciated exactly 10 times. There are 10 instances of the assignment var=var*2, as shown below. This is typically a synthesis or software compiler technique.

200000: var = var * 2; // i = 0
200001: var = var * 2; // i = 1
200002: var = var * 2; // i = 2
200003: var = var * 2; // i = 3
200004: var = var * 2; // i = 4
200005: var = var * 2; // i = 5
200006: var = var * 2; // i = 6
200007: var = var * 2; // i = 7
200008: var = var * 2; // i = 8
200010: var = var * 2; // i = 9
200011: . . . // code continues here: there is no JUMP

Generally, unrolled code yields faster execution times than invoked code. It avoids the control evaluations at the cost of increased instruction size. The compiler preferably analyzes the ratio between the instruction size and the control evaluation time. Typically, the larger the instruction size, the more favorable invocation is and vice versa, a small instruction code segment can be simply unrolled to avoid control operations.

Unrolled code can be combined with conditional checks to handle certain dynamic conditions. This is typically done in simulation acceleration when using synthesis. All unrolled branches are executed, but dynamic control is used to resolve the outcome. The example above could be implemented as:

```
if ( i < 0)
    ERROR - cannot handle i < 0 ;  // in this example
if ( i < 1 )  // i = 0 ;
    var = var * 2
if ( i < 2 )  // i = 1;
    var = var * 2
if ( i < 3 )  // i = 2;
    var = var * 2
if ( i < 4 )  // i = 3;
    var = var * 2
if ( i < 5 )  // i = 4;
    var = var * 2
if ( i < 6 )  // i = 5;
    var = var * 2
if ( i < 7 )  // i = 6;
    var = var * 2
if ( i < 8 )  // i = 7;
    var = var * 2
if ( i < 9 )  // i = 8;
    var = var * 2
if ( i < 10 )  // i = 9;
    var = var * 2
```

This example is correct for dynamic values of i being larger or equal to 0. In simulation acceleration, synthesis would synthesize all bodies and these are always executed. The flow is handled by multiplexing in sequence to obtain the desired result. As all branches are always executed, it should be obvious that any state machine information contained within the branch cannot be maintained. The state machine should only be updated if the body is executed. This is another limitation of the synthesized approach as it fails to handle behavioral code efficiently. Synthesis theoretically can handle the behavioral state machine by adding additional logic, but this typically would come at the cost of excessive amounts of logic.

Generally, unrolling is preferred under these conditions: 1) the loop parameters (start and end) can be statically determined (at compile time), 2) the body of the loop can be expanded within the current function (scope), and 3) the amount of scheduled code is within scheduling limits. It should be noted that synthesis techniques typically apply the unrolling technique to a loop and are therefore subject to these limitations.

Invoked code is code which is executed using jumps to another execution domain. In our example of functionA, calling subroutine functionB, the call to functionB in normal programming is usually implemented using a stack (push/pop). In the current architecture, this can be handled as a jump, and the stack operation is typically avoided (as it is deemed unnecessary overhead for small functions—for larger functions a stack mechanism can be made available). Both if-then-else and looping constructs can be in-lined or invoked. The distinction in a preferred embodiment is largely up to the scheduler. If the constructs are scheduled by a single program, in-lining is usually preferred, as a side-entrance instruction can be avoided. If the child execution domains are scheduled by a separate program (e.g. by a second CPU using the hierarchical compilation approach), invoking is preferred. It is merely code-arrangement in memory 121. Invoking usually requires bodies of code to be stacked, whereas in-lining can usually be done on-the-fly. Examples of in-lined and invoked code were given in Section 4.E. above. Note that neither in-lining or invoking is subject to the limitations of unrolling code. Hence they can be applied to constructs in simulation that are deemed “non-synthesizable.”

Now consider a general example of

for ( i = START ; i < END ; i++ ) body (i) ;
Let N_ITER = the number of iterations (N-ITER = END − START,
assuming that END >= START) and SIZE_OF_BODY = the size
of the body.

If N_ITER is static (i.e., can be determined at compile-time), then the number of iterations is known a priori. In this case, the body can be implemented as unrolled and the size of the unrolled code can be computed as SIZE_UNROLLED=N_ITER*SIZE_OF_BODY. In addition, regardless of whether N_ITER is static or dynamic, the body can also be implemented as in-lined (by using a jump within the execution domain to repeat the body N_ITER times) or as invoked (by jumping NJITER times to a separate execution domain containing the body).

If SIZE_UNROLLED is relatively small, then the unrolled approach is generally preferred (synthesizable). Otherwise, the SIZE_OF_BODY is used during compilation: the in-lined approach is generally preferred for relative small SIZE_OF_BODY whereas the invoked approach is generally preferred for relatively large SIZE_OF_BODY.

The code can also be implemented as a combination of both unrolled and in-lined/invoked code. Assume for this example that, although START and END may be dynamic, they do not change during execution of the following code:

```
    test = END − START ;
    if( test > MAX ) {
        CodeBlock1 // put in-lined or invoked code here, i.e. no
MAX iteration limit
    } else {
        CodeBlock2 // put unrolled code here, i.e. MAX iteration limit
    }
```

In this approach, the code is executed statically (unrolled) for up to MAX iterations and executed dynamically (invoked) for more than MAX iterations. This requires a larger instruction code, i.e. more storage for instruction code, but it generally allows further optimization of the performance. As discussed above in Section 4.F, this approach can yield domains CodeBlock1 and CodeBlock2 that can be dynamically chosen (based on the variable “test”). That is, the decision to use the static or dynamic approach is determined dynamically, during execution. That is, the compiler can optimize for both performance and size without compromising the logic. Domain CodeBlock1 is guaranteed to work for all values of test but is generally slower; domain CodeBlock2 is faster but works only for certain values of test. Choosing between the two code variants CodeBlock1 and CodeBlock2 can be done dynamically, as described above.

In a preferred embodiment, optimizations are done for both code minimization and execution speed. As code explosion usually is not a problem because of the off-chip (extremely large) instruction cache, execution speed optimization is typically preferred. More complicated mapping techniques, such as loop peeling and loop invariant code motion, can also be applied.

6.D. Synthesis Extensions for Behavioral Mapping.

In the context of logic simulation, the above discussion points out the limitations of synthesis in handling dynamic variables. Typically, synthesis is restricted to unrolling techniques and is required to generate complex state machines to handle dynamic controls. The complex state machines grow exponentially if behavior is to be mapped—as state variables must be generated for all possible combinations that may arise. Behavioral execution sidesteps this and is far more efficient for behavioral code. In addition, the described VLIW architecture enables further efficiency in mapping.

Specifically, some of the techniques that are applied to enable non-synthesizable logic to be handled are: conditional and unconditional branches, arbitrary sensitivity, behavioral registers that can be written to from multiple processes, and non-blocking assignments. Most of this disclosure deals with conditional and unconditional branching which enables mapping of unbounded loops. Examples for branching and looping are

.if <cond>, .else, .endif
.while <cond>, .endwhile
.label <label_name>
.goto <label_name>
.cgoto <cond> <label_name>

Arbitrary sensitivity is preferred for synthesis as synthesis typically rejects mixed edge and level sensitivity. Examples are:

.posedge <signal>
.negedge <signal>
.anyedge <signal>

Behavioral registers are registers that can be addressed by name, independent of clock domain mapping. These can be implemented using the temporary register space. This enables multiple processes to share registers, which also is not feasible through synthesis:

.reg <reg_name>

This is is contrast to the synthesized registers, which are of type:

.ff <ff_name> <clk> <options>

Non-blocking assignments in behavioral models often are intermixed with blocking assigns. Synthesis will reject this.

.nba <rhs> <lhs> // rhs = right hand side, lhs = left hand side

The inclusion of the aforementioned techniques generally require both the availability of the conditional and unconditional branch operand, coupled with the local memory 104 which gives all processors access to all temporaries at any time, coupled with clock domain scheduling and clock domain architecture, and combined with exception handlers of various types enables an efficient VLIW architecture which is capable of handling non-synthesizable tasks. This enables full language mapping for both hardware description language (HDL) and the more general behavioral languages. HDL languages have built-in parallelism which is leveraged through synthesis processes. The more general behavioral languages typically need extraction of parallelism for acceleration purposes, and its acceleration success depends on the application and code structure.

6.E. Parallelization

As explained above, the compiler can arbitrarily create the regions based on size and VLIW scheduling and packing efficiency. Now consider another element in the VLIW architecture: parallelization. Consider both programs and design (netlist).

In a design (e.g., netlist), which is already defined in terms of a parallel language (such as Verilog or VHDL), parallelization is realized by applying synthesis. This also scalarizes the logic and allows for efficient packing (i.e., many VLIW operations in a single execution domain). The cost is that many parallel paths are not needed, and that the VLIW does not realize its maximum potential, as explained in the multi-way branch section. As the compiler preferably optimizes for performance, and not for area (program code size), tradeoffs generally favor the execution time. When execution domains become too small, branching becomes less efficient, and enlargements techniques would yield a better performance. When enlargement techniques are used in large execution domains, the resulting redundant parallel path evaluation may cause excessive VLIW operations to take place, slowing down the execution speed.

By carefully creating regions, analyzing alternate variants and multi-way branching, applying region enlargement techniques and exception handlers, the compiler can optimize the resulting program mapping such that its execution is maximized, given a certain program memory 121 limit size. By using the techniques described herein, the compiler can convert the CFG (control flow graph), enabling efficient VLIW execution for both design (netlist) and (parallelized) programs.

In mapping user program code to the regions, the user program code usually is parallelized first. Many known techniques exist. A very specific type of parallelization is the mapping of NC problems (see Nick's Class section below). Using this technique can achieve better than linear acceleration compared to discrete processor solutions.

6.F. Schedule Construction: Compaction, Controls and Organization

Once the control flow graph has been decided upon, certain parts of the code will be invoked, unrolled or handled through exception handlers. The scheduler analyzes each execution domain and generates the VLIW scheduled code. This process is referred to as compaction. Care should be taken with side-entrance return constructs and the exception handlers that return (retrieve) data.

In the compiler, symbolic addresses are used during the scheduling. The control graph that connects all the execution domains is scheduled inside each domain. This process is referred to as adding controls.

Next, the scheduler organizes the domains. Essentially, this is the memory arrangement that connects all the jump addresses. These addresses are converted to physical memory addresses in the program memory 121, both relative and absolute to realize the memory arrangement as shown in FIGS. 3 and 8.

6.G. Summary

When mapping a large design/program, the regions are preferably formed such that a high level of instruction level parallelism (ILP) can be created. Using the region formation techniques described above, regions can be formed that can be optimized using the scheduling construction techniques described above.

Whether applied to large programs or large designs (netlists), the approach is generally the same. Each region that is carved out is scheduled for most efficiency. Regions are connected together using the control instructions (conditional branch, multi-way branch, unconditional branch, jump, NEXT_ADDR). Regions are enlarged using previously known enlargement techniques, as well as techniques such as exception handlers. Care is taken when a region has tail duplication as the exception handlers that are in-flight (such as behavioral modules: RetrieveData) should be respected. Depending on hardware implementation, there are both software and hardware solutions available to optimize this.

Referring again to FIG. 9, this figure shows how a program or a design (netlist) can be converted into a VLIW program. In region formation 910, the program/design is analyzed 911 and regions are built 912 such that execution can be made more efficient at the cost of extra program code. Typical techniques are tail duplication, loop unrolling, loop peeling, target expansion, etc. Each region of code is then parallelized 914, typically by mapping through a parallelizer program, i.e. an NC→PRAM schedule converter for programs and/or a synthesis step for design (netlist). Note that, typically, regions will not qualify for a true NC→PRAM or synthesis step. This is where exception handlers can be utilized to overcome these limitations (e.g. in a synthesis step the “non-synthesizable” constructs are mapped to these behavioral modules, enabling synthesis to be done for the remaining logic).

In schedule construction 920, the schedule is constructed for each region in the compaction step 922. Care should be given to side-entrance/return instructions and behavioral modules. Typically, scheduling is done using a combination of cycle based, linear and graph based techniques. Based on the region formation, the controls 924, implemented through conditional branching, unconditional branching, multi-way branching and behavioral modules are connected such that program integrity is assured. The output of each schedule construction forms the instruction domain (conglomerate of execution domains) for each (clock) domain.

The organization step 930 locates the scheduled instructions in memory. Schedule construction 920 can typically occur in parallel for each independent domain, as the generated code is relocatable. Organization 930 is a global step for all domains. In this step, the top-level control domain is created that connects (schedules) all of the other domains.

7. Multi-threading

7.A. Architecture Extensions

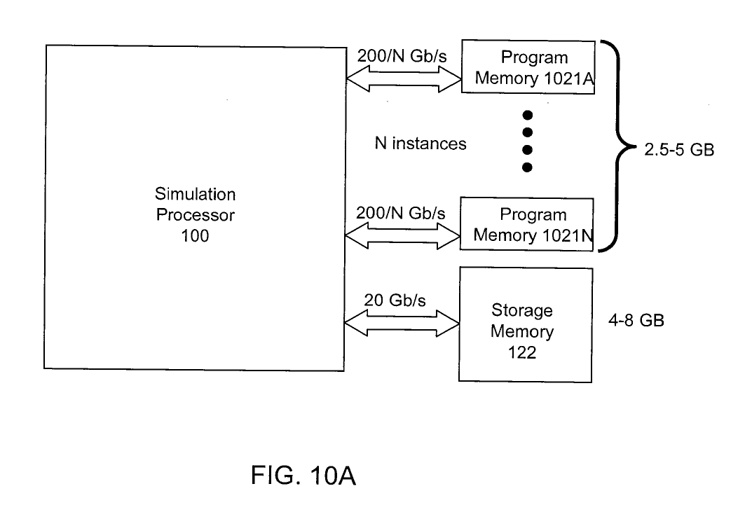

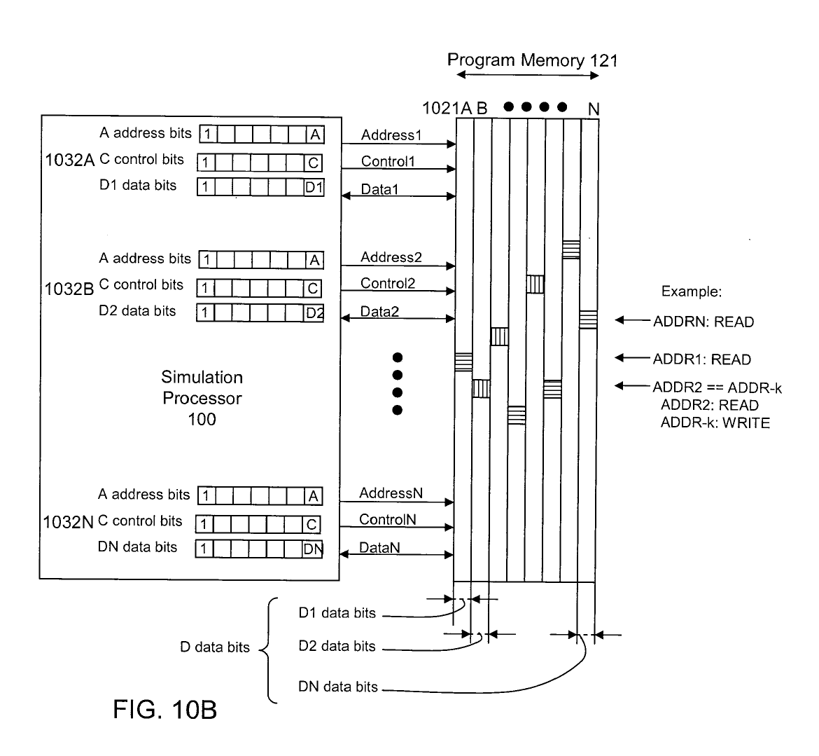

For simplicity, up to now the disclosure has assumed that all PEs 302 receive instructions from the same address in program memory 121. This is not required and multi-threading can be supported. FIGS. 10A and 10B are block diagrams illustrating an architecture for the program memory 121 suitable for multi-threading. In this example, the program memory 121 is not implemented as a single memory instance. Rather, it is implemented as N separate instances 1021A-1021N. If the total bandwidth to the program memory 121 is 200 Gb/s, then the memory bandwidth to each memory instance 1021 is 200/N Gb/s. In one implementation, each memory instance 1021 is a group of memory chips that is controlled by the same controller. Each group of memory chips typically includes between five to seven memory chips due to the required fanout for control signals versus maximum operating frequency for the controller.

Furthermore, as shown in FIG. 10B, the overall program memory 121 is organized into memory slices 1021A-1021N and each slice implemented by one of the memory instances 1021A-1021N. Each memory instance 1021 (or memory slice) is accessed by a separate memory controller 1032A-1032N, which are represented in FIG. 10B by address, control and data bits. In one specific implementation, the program memory 121 is physically realized as a reg [2,560] mem [8M]. In other words, the data width of the program memory 121 is D=2560 bits and there are 8M of these 2560-bit words. If there are N memory slices of equal width, then each slice 1021A-N contains 8M subwords of width 2560/N. More generally, memory slice 1021A is D1 bits wide, slice 1021B is D2 bits wide, etc. D1+D2+ . . . +DN=D. In FIG. 10B, memory memory slice 1021A is represented by the leftmost tall, skinny rectangle of the program memory 121. It is accessed by memory controller 1032A. Memory slice 1021B is represented by the next tall, skinny rectangle, and it is accessed by memory controller 1032B, and so on.

With this architecture, each memory slice 1021 can be accessed and controlled separately. Controller 1010A uses Address 1, Control 1 and Data 1. Control 1 indicates that data should be read from Address 1 within memory slice 1021A. Control 2 might indicate that data should be written to Address 2 within memory slice 1021B. Control 3 might indicate an instruction fetch (a type of data read) from Address 3 within memory slice 1021C, and so on. In this way, each memory slice 1021 can operate independently of the others. The memory slices 1021 can also operate together. If the address and control for all memory slices 1021 are the same, then an entire word of D bits will be written to (or read from) a single address within program memory 121.

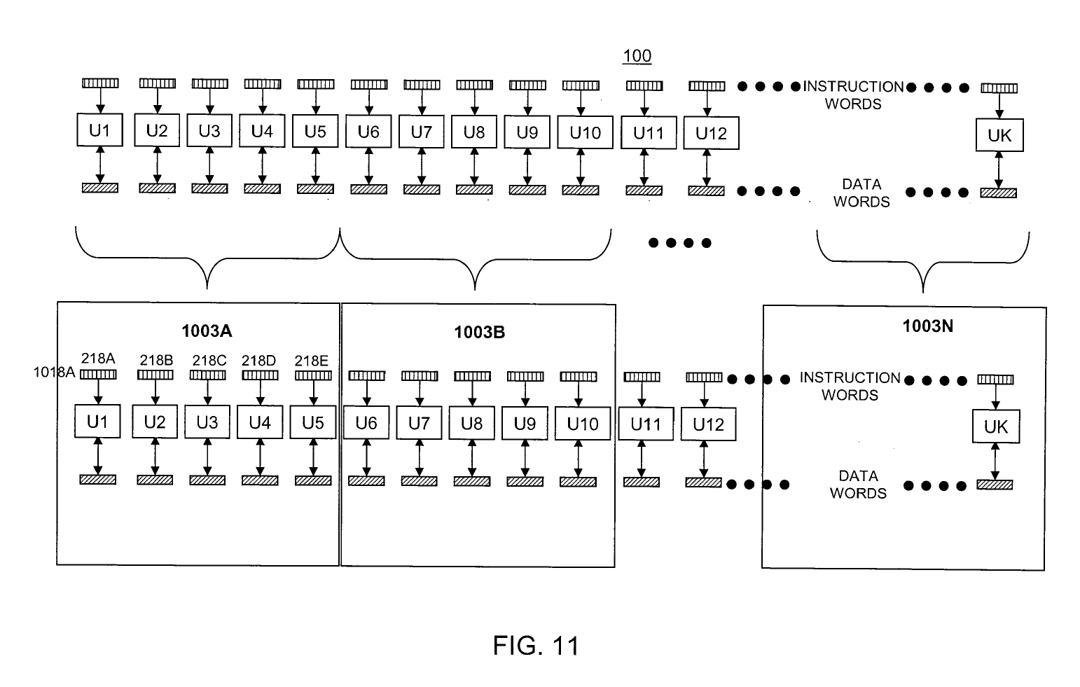

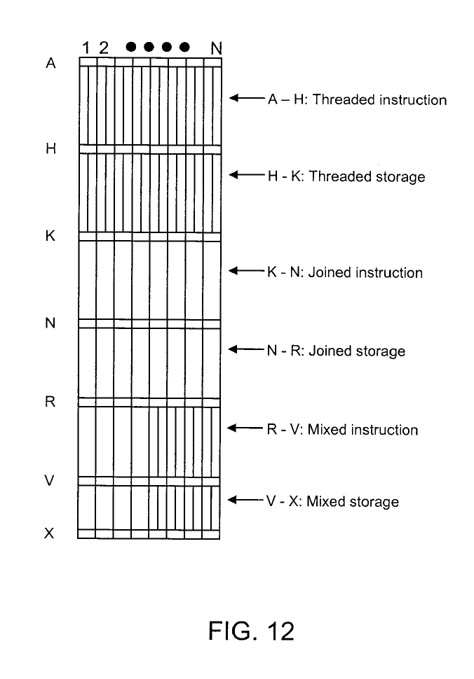

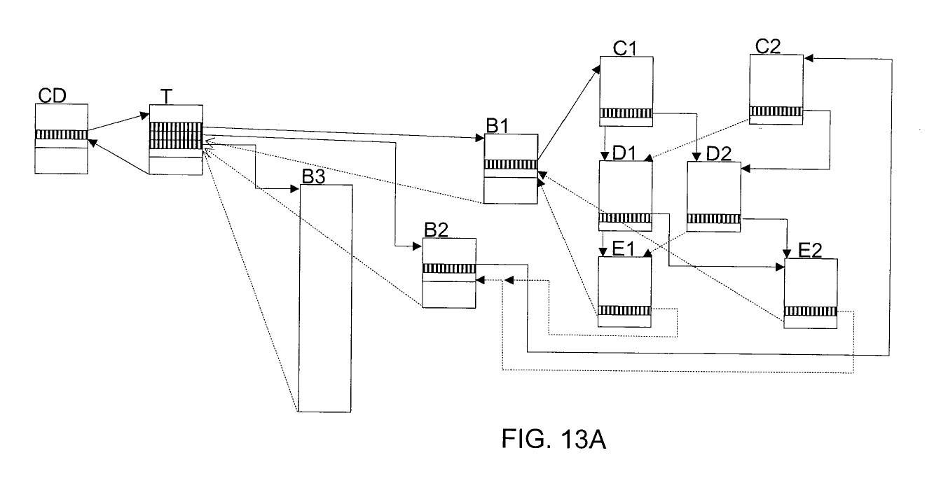

FIGS. 11 and 12 are block diagrams illustrating example organizations of the simulation processor 100 and program memory 121 to take advantage of this flexible capability. In FIG. 11, the simulation processor 100 includes K processor units U1-UK. The processor units are grouped into clusters 1003A-1003N, corresponding to the memory controllers 1032A-1032N and memory slices 1021A-1021N. Processor cluster 1003A includes five processor units U1-U5. Each processor unit can execute a PE instruction 218A-218E. The PE instructions 218A-218E together form a cluster instruction 1018A, which is D1 bits wide. Cluster instruction 1018B is D2 bits wide, cluster instruction 1018C is D3 bits wide, etc. All of the cluster instructions 1018A-1018N together form the VLIW instruction 118, which is D bits wide. Since each processor cluster 1003 corresponds to a different memory controller 1032, the corresponding cluster instructions 1018 can be fetched and executed independently for each cluster 1003. Thus, multi-threaded execution can be supported, as shown in FIG. 10B. Other instruction formats are possible. For example, all D1 bits could encode a cluster-level instruction that instructs the cluster as a whole how to behave, rather than encoding five separate PE instructions, each of PE instructions, each of which is D⅕ bits wide and instructs a single PE how to behave.

Typically, the instruction word width for each processor cluster, e.g. D1, is limited by physical realization, whereas the number of instruction bits per PE and also the number of data bits for storage are determined by architecture choices. As a result, D1 may not correspond exactly to the PE-level instruction width times the number of PEs in the processor cluster. Furthermore, additional bits typically are used to program various cluster-level behavior. If it is assumed that at least one of the PEs is idle in each cluster, then those PE-level instruction bits can be available to program cluster-level behavior. The widths of the cluster-level instructions can be consciously designed to optimize this mapping. As a result, cluster-level instructions for different processor clusters may have different widths.

FIG. 12 shows a memory organization to support multi-threaded execution. Here, program memory addresses A-H are dedicated to threaded instruction. Up to N threads can be active simultaneously. Addresses H-K are dedicated to threaded storage. Up to N independent reads/writes can be supported. Addresses K-N and N-R support joined instruction and storage, respectively. A common address is used to access the entire VLIW word, which is either a full VLIW instruction (addresses K-N) or a full VLIW data word (addresses N-R). Addresses R-V and V-X support mixed instruction and storage, respectively.

7.B. Multi-threaded Support for Branching

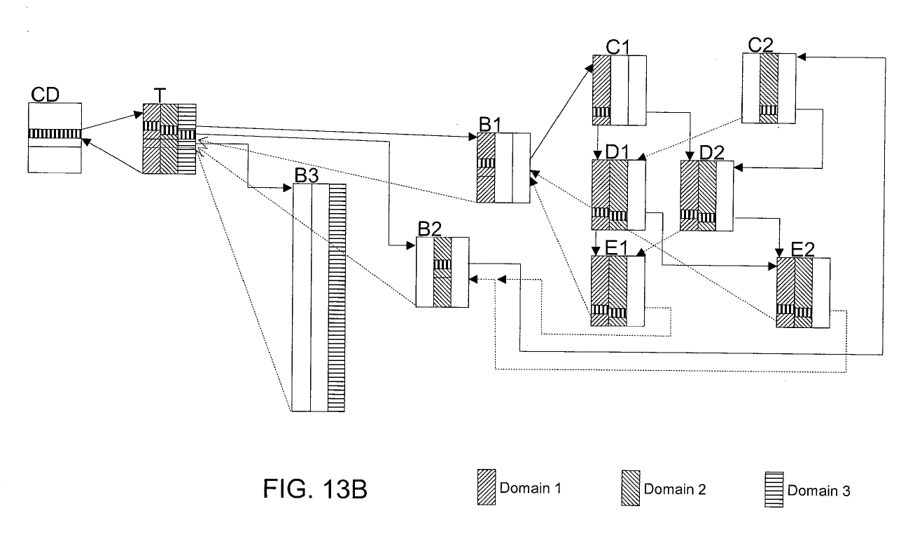

FIGS. 13A-13B are diagrams illustrating multi-threaded support for branching. In these figures, the vertically hatched rectangles are branch instructions, the solid arrows show initiation of the jump and the dotted arrows show the return. CD is the control domain, T is the top-level execution domain and Bn-Dn are lower-level execution domains. Thus, the vertically hatched areas in domain T indicates three possible branches to B1, B2 and B3. In this example, each branch may or may not be conditional and they may all be taken. Similarly, domain C1 indicates that a conditional branch could be made to domain D2 or, at the end of domain C1, an unconditional branch could be made to domain D1. For simplicity, assume that a sequence initiated by one of the Bn domains must return to the same Bn domain. Thus, a sequence B1→C1→D1→E1→B1 is a valid sequence, but B1→C1→D1→E2→B2 is not a valid sequence since it begins in B1 but returns to B2.

Valid sequences originating with one of the Cn domains are:

| | |
|---|---|
| C111: | C1→D1→E1 |
| C121: | C1→D2→E1 |
| C122: | C1→D2→E2 |
| C211: | C2→D1→E1 |
| C221: | C2→D2→E1 |
| C222: | C2→D2→E2 |

Using the above notation, valid sequences originating with one of the Bn domains are:

| | |
|---|---|
| B11: | B1→C111→B1 |
| B12: | B1→C121→B1 |
| B13: | B1→C122→B1 |
| B21: | B2→C211→B2 |
| B22: | B2→C212→B2 |
| B23: | B2→C222→B2 |
| B31: | B3 |
| But not: | B1→C1xx→B2 |
| And not | B2→C2xx→B1 |

And from the top module:
T→Bxx→T

FIG. 13B illustrates how the VLIW architecture can be utilized to enable multi-threading, in which jumps occur on the memory controller boundaries. In this case, three threads are formed corresponding to the three domains T→B1x→T, T→B2x→T and T→B3x→T. All three domains can be active simultaneously and independently on separate threads. That is, all three threads are not required to use instructions from the same address in the program memory. In one approach, the NEXT_ADDR return mechanism (back to the control domain) is enhanced with a JOIN or BARRIER technique. This guarantees that all parallel execution threads (B1x, B2x and B3x which can be active simultaneously) have completed, prior to continuation in the parent domain T. For example, domain T can be waiting on a simple counter to return to zero, where the counter counts how many threads are still active.

8. Differences Compared to Conventional VLIW Instructions

8.A. Architecture Characteristics

There are a number of (optional) architectural aspects about the VLIW simulation processor which help to make this type of approach feasible. The numbers given below are specific to the example implementation described above but are not meant to be limiting.

Instruction cache-less. Unlike most VLIW processor architectures, the current architecture does not cache the instructions. Instructions stream in from the program memory 121 and the processor elements 302 are programmed continuously based on the instruction words. Code branching therefore comes at almost no execution penalty, unlike instruction cache based VLIW processor architectures. If the memory address pointer is at X, and the next address is Y and not X+1, the only cost is the memory latency, which is measured as a few clock cycles and implemented using delayed branching techniques. Execution of large programs/designs is estimated at multi 100,000 cycles. The cost of branching to a side-entrance (or return branch) is removal of dependency on temporaries and global variables—or preservation of the temporaries and rotating the shift registers to a known state. This translates in scheduling constraints that could typically affect up to a few hundred cycles. The impact is not a loss of those cycles, rather a less efficient execution (e.g. temporaries that were already available for processing (-shift register-) are stored prior to the jump and retrieved after the jump.

Shared on-chip memory. Another architecture feature is that all processor elements 302 have access to all available on-chip memory 104, under scheduling control. The on-chip memory 104 is a rather large data cache which is loaded from the main memory. A complete data cache refresh (fetch) requires only a few 1,000 cycles, which is insignificant with respect to the overall compute time, and usually much smaller amounts are required.

PRAM (Parallel random access machine!. This architecture is also flexible with respect to scheduling. The basic VLIW processor width is set to 64, but this can be varied. This means that 64 processor elements 302 execute once per instruction cycle. If an algorithm requires less than 64 parallel operations, the algorithm would be paired up with other, parallel executed, algorithm. However, if an algorithm requires more than 64 parallel operations, the higher numbers of operations are performed through sequential instruction cycles. All processor elements can have access to the memory at the same time. In other words, a PRAM-like architecture can be realized which allows flexible number of processor scaling. If n is the number of required processor elements, the PRAM cycle completes in one VLIW instruction cycle for n up to 64. One PRAM cycle takes two VLIW instruction cycles for n between 65 and 128, and so forth. If the algorithm requires 1,000 processors to all exchange data through memory, the PRAM cycle constitutes 10 VLIW cycles.

The shared memory is implemented as distributed memory, but available to all processor elements under a scheduled approach. The compiler ensures that each processor element has access to memory data when it is scheduled.

Nick's Class. The flexible number of processor elements, coupled with the PRAM architecture, enables efficient scheduling of a certain class of algorithms, commonly referred to as Nick's Class, or NC. NC problems are defined as problems that can be solved in polylogarithmic time on a parallel computer with a polynomial number of processors. In other words, a problem is in NC if there are constants c and k such that it can be solved in time O((log n)**c) using O(n**k) parallel processors. Equivalently, NC can be defined as those decision problems decidable by uniform Boolean circuits with polylogarithmic depth and a polynomial number of gates. This translates into known techniques that can be used to parallelize algorithms, which can be compiled similarly to the netlist compilation process for optimal performance.

Applications that have inherent parallelism are good candidates for this processor architecture. In the area of scientific computing, examples include climate modeling, geophysics and seismic analysis for oil and gas exploration, nuclear simulations, computational fluid dynamics, particle physics, financial modeling and materials science, finite element modeling, and computer tomography such as MRI. In the life sciences and biotechnology, computational chemistry and biology, protein folding and simulation of biological systems, DNA sequencing, pharmacogenomics, and in silico drug discovery are some examples. Nanotechnology applications may include molecular modeling and simulation, density functional theory, atom-atom dynamics, and quantum analysis. Examples of digital content creation include animation, compositing and rendering, video processing and editing, and image processing.

Power and Speed. The VLIW processor performance ties in with the memory bandwidth (200 Gb/s in one implementation). If each of the 64 processor elements is realized as a floating point based processor, the sustained compute rate would be well over 5 GFLOPS. This is not the maximum attainable performance, but rather the steady state attainable. It only needs to be derated by the efficiency of the algorithmic scheduling. This is significantly larger than what can be attained by current single processor CPUs (typically 100 MFLOPS for certain classes of problems). In one implementation, described in U.S. patent application Ser. No. 11/318,042, “Processor,” by Verheyen, Mathur and Watt, filed Dec. 23, 2005 and which is incorporated herein by reference, the VLIW simulation processor realizes this compute performance while consuming less than, on average, 5 W of power.

8.B. Advantages

As a result in part of the architecture characteristics described above, various implementations may have some or all of the following advantages and/or differences compared to conventional VLIW systems.

No stack (when jumping). The VLIW system can be implemented so that subroutines operate on global variables and have either conditional and/or unconditional return addresses. Recursion is generally not needed in this approach. Multiple iterations are handled by the invoking domain, not by the domain currently executing. If desired, a stack mechanism can be implemented, allowing recursion. In this mechanism, the invoked domains have restricted schedules, which remove most of the overhead of the push and pop.

Cache coherence problems are avoided. In the VLIW architecture, there is no on-chip instruction cache. The program memory can be thought of as an extremely large (effectively, infinite) off-chip instruction cache. Each instruction is directly fetched from program memory 121. Because of this, there is no need for advanced scheduling methods, such as region based, or trace based algorithms. Rather, the execution domain can freely jump to any other address in the memory space for continuation.

Simplified region formation. As described above, region formation can be greatly simplified due to the single cycle branching constructs, the exception handlers, and the region enlargement techniques. Allowing side-entrances into regions, without the traditional bookkeeping costs, greatly enhances the compiler's ability to map more complex language constructs and the efficiency of the VLIW execution. Typical VLIW scheduling restrictions that apply to region formation are lifted, and the compiler has significantly greater mapping flexibility.

Simplified ILP Scheduling. Instruction level parallelism can be done in each execution domain by a graph based covering algorithm which selects the most efficient manner to pack all instructions across the number of processor elements. The goal usually is to minimize minimize the number of steps required to execute this domain.

Handling of Non-Synthesizable Tasks. In simulation acceleration applications, this VLIW architecture enables mapping of non-synthesizable tasks, through a multitude of solutions, enabling “whole language” mapping, which typically is not achievable by the traditional, synthesized based, simulation acceleration methods. In general language applications, the same benefits can be derived.

9. Further Examples

Although the present invention has been described above with respect to several embodiments, various modifications can be made within the scope of the present invention. For example, although the present invention is described in the context of PEs that are the same, alternate embodiments can use different types of PEs and different numbers of PEs. The PEs also are not required to have the same connectivity. PEs may also share resources. For example, more than one PE may write to the same shift register and/or local memory. The reverse is also true, a single PE may write to more than one shift register and/or local memory.

In another aspect, the simulation processor 100 of the present invention can be realized in ASIC (Application-Specific Integrated Circuit) or FPGA (Field-Programmable Gate Array) or other types of integrated circuits. It also need not be implemented on a separate circuit board or plugged into the host computer 110. There may be no separate host computer 110. For example, referring to FIG. 1, CPU 114 and simulation processor 100 may be more closely integrated, or perhaps even implemented as a single integrated computing device.

Although the present invention is described in the context of logic simulation for semiconductor chips, the VLIW processor architecture presented here can also be used for other applications. In showing the flexibility of the VLIW architecture with conditional branching, note that general sequential programming languages, such as C or C++, can be supported fairly easily (similar to standard compile on single processor solutions). They lack the inherent parallel parallel behavior of hardware description languages such as Verilog or VHDL, but for many applications, parallel algorithms have been identified and can be used to enable acceleration of such sequential programming languages. Examples are matrix multiplications and correlation functions. The described VLIW architecture easily extends beyond logic simulation and the hardware description languages, and that acceleration can be achieved for many other applications depending on parallelization of the program and data access within the algorithms.

For example, the processor architecture can be extended from single bit, 2-state, logic simulation to 2 bit, 4-state logic simulation, to fixed width computing (e.g., DSP programming), and to floating point computing (e.g. IEEE-754). Applications that have inherent parallelism are good candidates for this processor architecture. In the area of scientific computing, examples include climate modeling, geophysics and seismic analysis for oil and gas exploration, nuclear simulations, computational fluid dynamics, particle physics, financial modeling and materials science, finite element modeling, and computer tomography such as MRI. In the life sciences and biotechnology, computational chemistry and biology, protein folding and simulation of biological systems, DNA sequencing, pharmacogenomics, and in silico drug discovery are some examples. Nanotechnology applications may include molecular modeling and simulation, density functional theory, atom-atom dynamics, and quantum analysis. Examples of digital content creation include animation, compositing and rendering, video processing and editing, and image processing.

As a specific example, if the PEs are capable of integer or floating point arithmetic (as described in U.S. patent application Ser. No. 11/552,141, “VLIW Acceleration System Using Multi-State Logic,” filed Oct. 23, 2006, hereby incorporated by reference in its entirety), the VLIW architecture described above enables a general purpose data driven computer to be created. For example, the stimulus data might be raw data obtained by computer tomography. The hardware accelerator 130 is an integer or floating point accelerator which produces the output data, in this case the 3D images that need to be computed.

Depending on the specifics of the application, the hardware accelerator can be event-driven or cycle-based (or, more generally, domain-based). In the domain-based approach, the problem of computing the required 3D images is subdivided into “subproblems” (e.g., perhaps local FFTs). These “subproblems” are analogous to the domains described above, and the techniques described above with respect to these domains can also be applied to this situation.

The multi-threading and clustering techniques described in FIGS. 10-13 can also be used in applications other than logic simulation. For example, the PEs can be clustered to perform certain arithmetic tasks. As another example, different threads can be used to evaluate different problem domains simultaneously.

Various other modifications, changes and variations which will be apparent to those skilled in the art may be made in the arrangement, operation and details of the method and apparatus of the present invention disclosed herein without departing from the spirit and scope of the invention as defined in the appended claims. Therefore, the scope of the invention should be determined by the appended claims and their legal equivalents.

What is claimed is:

1. A hardware accelerated logic simulation system for logic simulation of a circuit design, comprising:
a VLIW simulation processor containing a plurality of parallel processing elements, wherein the processing elements are operable to execute instructions included in a supported instruction set; the instructions implementing synthesizable tasks, non-synthesizable tasks and branching for the logic simulation; and
a program memory containing the instructions, wherein the instructions are streamed directly from the program memory to the processing elements without use of an on-chip instruction cache.

2. The system of claim 1 wherein the synthesizable tasks include simulation of user logic in the circuit design.

3. The system of claim 1 wherein the non-synthesizable tasks include simulation of behavioral models of the circuit design.

4. The system of claim 1 wherein the non-synthesizable tasks include test bench functions for the logic simulation.

5. The system of claim 1 wherein the non-synthesizable tasks include overall control of the logic simulation.

6. The system of claim 1 further comprising:
a program counter register that points to an address in program memory for the instructions to be streamed to the processing elements, wherein execution of an instruction for branching loads a new address into the program counter register.

7. The system of claim 6 wherein the instructions implementing branching include a global jump instruction.

8. The system of claim 6 wherein the instructions implementing branching include a relative jump instruction.

9. The system of claim 6 wherein the instructions implementing branching include a conditional jump instruction.

10. The system of claim 6 wherein the instructions implementing branching include an unconditional jump instruction.

11. The system of claim 6 wherein the instructions implementing branching include a multi-way branch instruction.

12. The system of claim 11 wherein the multi-way branch instruction is implemented as a set of conditional branch instructions, with each of the conditional branch instructions executed simultaneously by a different processing element.

13. The system of claim 6 wherein at least one of the instructions implementing branching is encoded as a field overload.

14. The system of claim 6 wherein the instructions are divided into regions and at least one of the instructions implementing branching is a side-entrance jump from an invoking region to an invoked region.

15. The system of claim 14 wherein, after the side-entrance jump to the invoked region upon return to the invoking region, the temporary variables for the invoking region have been preserved at the same locations as before the side-entrance jump.

16. The system of claim 14 wherein, after the side-entrance jump to the invoked region upon return to the invoking region, the temporary variables for the invoking region have been preserved but at different locations and are restored to the original locations before the side-entrance jump.

17. The system of claim 14 wherein, after the side-entrance jump to the invoked region upon return to the invoking region, the temporary variables for the invoking region have not been preserved and are reloaded and/or recomputed.

18. The system of claim 14 wherein, after the side-entrance jump to the invoked region upon return to the invoking region, the temporary variables can be restored deterministically based on the architecture of the VLIW processor, not of the program that was mapped/scheduled.

19. The system of claim 6 wherein the program memory includes alternate variant execution domains optimized for different dynamic conditions, and the VLIW simulation processor branches to one of the alternate variant execution domains based on evaluation of a control variable for the dynamic condition.

20. The system of claim 19 wherein one of the alternate variant execution domains includes an unrolled version of code and another of the alternate variant execution domains includes either an in-lined or an invoked version of the same code.

21. The system of claim 19 wherein one of the alternate variant execution domains implements dead code elimination assuming a certain state of the dynamic condition.

22. The system of claim 19 wherein one of the alternate variant execution domains implements constant propagation assuming a certain state of the dynamic condition.

23. The system of claim 1 wherein execution of an instruction for a non-synthesizable task invokes an exception handler.

24. The system of claim 23 wherein the exception handler and the VLIW simulation processor are implemented on a same chip.

25. The system of claim 23 wherein the exception handler, the VLIW simulation processor and the program memory are implemented on a same printed circuit board.

26. The system of claim 23 wherein the exception handler is executed by hardware in a host computer for the hardware accelerated logic simulation system.

27. The system of claim 23 wherein the exception handler is executed by host software for the hardware accelerated logic simulation system.

28. The system of claim 23 wherein the exception handler executes in parallel with the processing elements of the VLIW simulation processor.

29. The system of claim 1 further comprising:
a host computer; and
a printed circuit board plugged into the host computer, the printed circuit board containing the VLIW simulation processor implemented as a single chip and further containing the program memory.

30. The system of claim 1 further comprising:
a program counter register that points to addresses in program memory for the instructions to be streamed to the processing elements, wherein simultaneously different processing elements can receive instructions streamed in from different addresses in program memory.

31. A method for logic simulation of a circuit design, comprising:
storing instructions from a supported instruction set in a program memory;
streaming the instructions directly from the program memory to the processing elements of a VLIW simulation processor without use of an on-chip instruction cache; and
the processing elements executing the instructions, the instructions implementing synthesizable tasks, non-synthesizable tasks and branching for the logic simulation.

32. A method for compiling a circuit design into a program containing instructions from a supported instruction set for logic simulation of the circuit design, the method comprising:
partitioning the circuit design into regions;
parallelizing instructions within each region; and
constructing a schedule for the regions; wherein the instructions in the regions are to be streamed directly from a program memory to processing elements of a VLIW simulation processor without use of an on-chip instruction cache; the instructions implement synthesizable tasks, non-synthesizable tasks and branching for the logic simulation; and at least one region includes a side-entrance jump into the region.

33. The method of claim 32 wherein at least one region includes two or more side-entrance jumps into the region.

34. The method of claim 32 wherein at least one region includes invoking an exception handler to implement a non-synthesizable task.

35. The method of claim 32 wherein the step of parallelizing instructions within each region comprises determining whether to implement a loop within the region as an unrolled version, an in-lined version and/or an invoked version.

36. The method of claim 35 wherein, according to the determining step:
the loop is implemented as an unrolled version if the number of iterations of the loop is static and the unrolled size of the loop is relatively small;
the loop is implemented as an in-lined version if the number of iterations of the loop is dynamic and the size of the loop is relatively small; and
the loop is implemented as an invoked version if the number of iterations of the loop is dynamic and the size of the loop is relatively large.

37. The method of claim 35 wherein, according to the determining step, the loop is implemented as two or more of the unrolled, in-lined and invoked versions and the region further includes a conditional branch instruction for selecting among the unrolled, in-lined and invoked versions based on dynamic evaluation of a control variable.

38. The method of claim 32 wherein the step of parallelizing instructions within each region comprises:
implementing alternate variant execution domains optimized for different dynamic conditions; and
including a conditional branch instruction for selecting among the alternate variant execution domains based on dynamic evaluation of a control variable for the dynamic condition.

39. The method of claim 32 wherein the step of partitioning the circuit design into regions comprises
forming separate regions from fully synthesizable blocks of tasks; and
using region enlargement techniques to combine said separate regions into larger regions.

40. The method of claim 39 wherein the step of using region enlargement techniques comprises invoking exception handlers to implement non-synthesizable tasks separating regions, thereby allowing the combination of the separate regions into a larger region.

41. The method of claim 39 wherein the step of using region enlargement techniques comprises using branching to connect separate regions, thereby allowing the combination of the separate regions into a larger region.

42. The method of claim 39 wherein the step of using region enlargement techniques comprises using side-entrance branching to connect separate regions, thereby allowing the combination of the separate regions into a larger region.

43. A computer readable storage medium containing software instructions to cause a processor to execute a method for compiling a circuit design into a program containing instructions from a supported instruction set for logic simulation of the circuit design, the method comprising:
partitioning the circuit design into regions;
parallelizing instructions within each region; and
constructing a schedule for the regions; wherein the instructions in the regions are to be streamed directly from a program memory to processing elements of a VLIW simulation processor without use of an on-chip instruction cache; the instructions implement synthesizable tasks, non-synthesizable tasks and branching for the logic simulation; and at least one region includes a side-entrance jump into the region.

44. A VLIW processor containing a plurality of parallel processing elements, wherein the processing elements are operable to execute instructions included in a supported instruction set; the instructions implementing synthesizable tasks, non-synthesizable tasks and branching; and wherein the instructions are streamed directly from a program memory to the processing elements without use of an on-chip instruction cache.
